(19) United States
(12) Patent Application Publication
(10) Pub. No.: US 2025/0192833 A1
(43) Pub. Date: Jun. 12, 2025

(54) TERMINAL, RADIO COMMUNICATION METHOD, AND BASE STATION

(71) Applicant: NTT DOCOMO, INC., Tokyo (JP)

(72) Inventors: Yuki Matsumura, Tokyo (JP); Satoshi Nagata, Tokyo (JP); Jing Wang, Beijing (CN); Lan Chen, Beijing (CN)

(73) Assignee: NTT DOCOMO, INC., Tokyo (JP)

(21) Appl. No.: 18/846,489

(22) PCT Filed: Mar. 25, 2022
(86) PCT No.: PCT/JP2022/014689

§ 371 Date: Sep. 12, 2024

(51) Int. Cl. H04B 7/0456; H04B 7/0452

(52) U.S. Cl. CPC H04B 7/0456; H04B 7/0452

(57) ABSTRACT

A terminal according to one aspect of the present disclosure includes a control section that determines a precoder, based on a codebook for transmission with a certain number of layers, the transmission using more than four antenna ports, and a transmitting section that performs uplink transmission, based on the precoder. According to one aspect of the present disclosure, it is possible to appropriately control UL transmission using more than four antenna ports.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In Rel-15 NR, uplink (UL) Multi Input Multi Output (MIMO) transmission with up to four layers is supported. For future NR, it is studied that UL transmission with more than four layers is supported for achieving higher spectrum efficiency. For example, for Rel-18 NR, up to 6 rank transmission using 6 antenna ports, up to 6 or 8 rank transmission using 8 antenna ports, and the like are under study.

However, a study of how to determine a precoding matrix for UL transmission using more than four antenna ports has not yet been advanced. For example, a study of codebooks for 1 to 8-layer transmissions using 8 antenna ports has not yet been advanced. Unless this is made clear, an increase in communication throughput may be suppressed.

Thus, an object of the present disclosure is to provide a terminal, a radio communication method, and a base station that can appropriately control UL transmission using more than four antenna ports.

### Solution to Problem

A terminal according to one aspect of the present disclosure includes a control section that determines a precoder, based on a codebook for transmission with a certain number of layers, the transmission using more than four antenna ports, and a transmitting section that performs uplink transmission, based on the precoder.

### Advantageous Effects of Invention

According to one aspect of the present disclosure, it is possible to appropriately control UL transmission using more than four antenna ports.

### BRIEF DESCRIPTION OF DRAWINGS

FIG. 1 is a diagram to show an example of a table of precoding matrices W for single-layer (rank 1) transmission using 4 antenna ports in Rel-16 NR in a case where a transform precoder is disabled.

FIG. 2 is a diagram to show an example of a table of precoding matrices W for 2-layer (rank 2) transmission using 4 antenna ports in Rel-16 NR in a case where a transform precoder is disabled.

FIG. 3 is a diagram to show an example of a table of precoding matrices W for 3-layer (rank 3) transmission using 4 antenna ports in Rel-16 NR in a case where a transform precoder is disabled.

FIG. 4 is a diagram to show an example of a table of precoding matrices W for 4-layer (rank 4) transmission using 4 antenna ports in Rel-16 NR in a case where a transform precoder is disabled.

FIG. 5 is a diagram to show an example of correspondence between a value of a precoding information and number of layers field, and the number of layers and a TPMI in Rel-16 NR.

FIGS. 6A and 6B are diagrams to show examples of an antenna layout of 8 antenna ports.

FIG. 7 is a diagram to show an example of an 8-antenna port antenna layout for description of coherent information of a first embodiment.

FIGS. 8A and 8B are diagrams to show examples of an 8-port 1-layer NC precoder to be supported, according to a second embodiment.

FIG. 9 is a diagram to show an example of an 8-port 1-layer PC precoder to be supported, according to a third embodiment.

FIGS. 10A to 10C are diagrams to show examples of an 8-port 1-layer PC precoder (x=2) to be supported, according to Embodiment 3.3.

FIGS. 11A and 11B are diagrams to show examples of a codebook for 1-layer CSI reporting using P_{CSI-RS} antenna ports in existing Rel-15/16 NR.

FIGS. 12A and 12B are diagrams to show examples of a codebook for 1-layer CSI reporting using P_{CSI-RS} antenna ports in existing Rel-15/16 NR.

FIG. 13 is a diagram to show an example of associations between precoders according to second to fourth embodiments and TPMI indices.

FIG. 14 is a diagram to show an example of an 8-transmission UL codebook according to variation of a fourth embodiment.

FIGS. 15A to 15C are diagrams to show examples of an 8-port 2-layer NC precoder to be supported, according to a fifth embodiment.

FIG. 16 is a diagram to show an example of an 8-port 2-layer NC precoder to be supported, according to the fifth embodiment.

FIG. 17 is a diagram to show an example of an 8-port 2-layer PC precoder according to a sixth embodiment.

FIGS. 18A and 18B are diagrams to show examples of a codebook for 2-layer CSI reporting using P_{CSI-RS} antenna ports in existing Rel-15/16 NR.

FIGS. 19A and 19B are diagrams to show examples of a codebook for 2-layer CSI reporting using P_{CSI-RS} antenna ports in existing Rel-15/16 NR.

FIG. 20 is a diagram to show an example of a schematic structure of a radio communication system according to one embodiment.

FIG. 21 is a diagram to show an example of a structure of a base station according to one embodiment.

FIG. 22 is a diagram to show an example of a structure of a user terminal according to one embodiment.

FIG. 23 is a diagram to show an example of a hardware structure of the base station and the user terminal according to one embodiment.

FIG. 24 is a diagram to show an example of a vehicle according to one embodiment.

### DESCRIPTION OF EMBODIMENTS

### (SRS and PUSCH Transmission Control)

In Rel-15 NR, a terminal (user terminal, User Equipment (UE)) may receive information to be used for transmission of a reference signal for measurement (for example, sounding reference signal (SRS)) (SRS configuration information, for example, a parameter in an RRC control element “SRS-Config”).

Specifically, the UE may receive at least one of information related to one or a plurality of SRS resource sets (SRS resource set information, for example, an RRC control element “SRS-ResourceSet”) and information related to one or a plurality of SRS resources (SRS resource information, for example an RRC control element “SRS-Resource”).

One SRS resource set may be related to a certain number of SRS resources (may group the certain number of SRS resources). Each SRS resource may be identified by an SRS resource indicator (SRI) or an SRS resource ID (Identifier).

The SRS resource set information may include an SRS resource set ID (SRS-ResourceSetId), a list of SRS resource IDs (SRS-ResourceId) used in the resource set, an SRS resource type, and information of SRS usage.

Here, the SRS resource type may indicate any one of a periodic SRS (P-SRS), a semi-persistent SRS (SP-SRS), and aperiodic CSI (Aperiodic SRS (A-SRS)). Note that the UE may periodically (or, after activation, periodically) transmit the P-SRS and the SP-SRS, and may transmit the A-SRS, based on an SRS request of DCI.

The usage (RRC parameter “usage,” L1 (Layer-1) parameter “SRS-SetUse”) may be, for example, beam management (beamManagement), codebook (CB), non-codebook (noncodebook (NCB)), antenna switching, or the like. An SRS with codebook or non-codebook usage may be used to determine a precoder for codebook based or non-codebook based uplink shared channel (Physical Uplink Shared Channel (PUSCH)) transmission based on an SRI.

For example, in a case of codebook-based transmission, the UE may determine a precoder (precoding matrix) for the PUSCH transmission, based on an SRI, a transmitted rank indicator (TRI), and a transmitted precoding matrix indicator (TPMI). In a case of non-codebook-based transmission, the UE may determine a precoder for the PUSCH transmission, based on the SRI.

The SRS resource information may include an SRS resource ID (SRS-ResourceId), the number of SRS ports, an SRS port number, a transmission Comb, SRS resource mapping (for example, a time and/or frequency resource location, resource offset, a resource periodicity, the number of repetitions, the number of SRS symbols, an SRS bandwidth, or the like), hopping-related information, an SRS resource type, a sequence ID, SRS spatial relation information, and the like.

The SRS spatial relation information (for example, an RRC information element “spatialRelationInfo”) may indicate information about a spatial relation between a certain reference signal and an SRS. The certain reference signal may be at least one of a synchronization signal/broadcast channel (Synchronization Signal/Physical Broadcast Channel (SS/PBCH)) block, a channel state information reference signal (CSI-RS), and an SRS (for example, another SRS). The SS/PBCH block may be referred to as a synchronization signal block (SSB).

The SRS spatial relation information may include, as an index of the above certain reference signal, at least one of an SSB index, a CSI-RS resource ID, and an SRS resource ID.

Note that, in the present disclosure, an SSB index, an SSB resource ID, and an SSB Resource Indicator (SSBRI) may be interchangeably interpreted. A CSI-RS index, a CSI-RS resource ID, and a CSI-RS Resource Indicator (CRI) may be interchangeably interpreted. An SRS index, an SRS resource ID, and an SRI may be interchangeably interpreted.

The SRS spatial relation information may include a serving cell index, a BWP index (BWP ID), and the like corresponding to the above certain reference signal.

With respect to a certain SRS resource, when configured with spatial relation information related to an SSB or CSI-RS and an SRS, the UE may transmit the SRS resource by using the same spatial domain filter (spatial domain transmission filter) as a spatial domain filter (spatial domain reception filter) for reception of the SSB or CSI-RS. In this case, the UE may assume that a UE receive beam of the SSB or CSI-RS and a UE transmit beam of the SRS are the same.

With respect to a certain SRS (target SRS) resource, when configured with spatial relation information related to another SRS (reference SRS) and the SRS (target SRS), the UE may transmit the target SRS resource by using the same spatial domain filter (spatial domain transmission filter) as a spatial domain filter (spatial domain transmission filter) for transmission of the reference SRS. In other words, in this case, the UE may assume that a UE transmit beam of the reference SRS and a UE transmit beam of the target SRS are the same.

The UE may determine, based on a value of a certain field (for example, an SRS resource indicator (SRI) field) in DCI (for example, DCI format 0_1), a spatial relation for a PUSCH scheduled by the DCI. Specifically, the UE may use, for PUSCH transmission, spatial relation information (for example, an RRC information element “spatialRelationInfo”) of an SRS resource determined based on the value of the certain field (for example, the SRI).

In Rel-15/16 NR, when codebook based transmission is used for a PUSCH, the UE may be configured with an SRS resource set including up to two SRS resources with codebook usage, by RRC, and may be indicated with one of the up to two SRS resources by DCI (one-bit SRI field). A transmit beam for the PUSCH is indicated by the SRI field.

The UE may judge a TPMI and the number of layers (transmission rank) for the PUSCH, based on a precoding information and number of layers field (also referred to hereinafter as a precoding information field). The UE may select, based on the TPMI, the number of layers, and the like above, a precoder from an uplink codebook for the same number of ports as the number of SRS ports indicated by a higher layer parameter “nrofSRS-Ports” configured for an SRS resource indicated by the above SRI field.

In Rel-15/16 NR, when non-codebook based transmission is used for a PUSCH, the UE may be configured with an SRS resource set including up to four SRS resources with non-codebook usage, by RRC, and may be indicated with one or more of the up to four SRS resources by DCI (two-bit SRI field).

The UE may determine the number of layers (transmission rank) for the PUSCH, based on the SRI field. For example, the UE may judge that the number of SRS resources indicated by the SRI field is the same as the number of layers for the PUSCH. The UE may calculate a precoder for the SRS resource.

When a CSI-RS related to the SRS resource (or SRS resource set to which the SRS resource belongs) (which may be referred to as an associated CSI-RS) is configured in a higher layer, a transmit beam for the PUSCH may be calculated based on (measurement of) the configured related CSI-RS. Otherwise, a transmit beam for the PUSCH may be indicated by an SRI.

Note that the UE may be configured with whether to use codebook based PUSCH transmission or use non-codebook based PUSCH transmission by a higher layer parameter “txConfig” indicating a transmission scheme. The parameter may indicate a value of “codebook” or “non-codebook (nonCodebook).”

In the present disclosure, a codebook based PUSCH (codebook based PUSCH transmission, codebook based transmission) may mean a PUSCH when the UE is configured with “codebook” as a transmission scheme. In the present disclosure, a non-codebook based PUSCH (non-codebook based PUSCH transmission, non-codebook based transmission) may mean a PUSCH when the UE is configured with “non-codebook” as a transmission scheme.

### (Determination of PUSCH Precoder in Codebook (CB) Based Transmission)

As mentioned above, in a case of codebook (CB) based transmission, the UE may determine a precoder for the PUSCH transmission, based on the SRI, TRI, TPMI, and the like.

The UE may be notified of the SRI, the TRI, the TPMI, and the like by using downlink control information (DCI). The SRI may be indicated by an SRS Resource Indicator field (SRI field) of the DCI or may be indicated by a parameter “srs-ResourceIndicator” included in an RRC information element “ConfiguredGrantConfig” for a configured grant PUSCH.

The TRI and the TPMI may be indicated by precoding information and number of layers field (“Precoding information and number of layers” field) of the DCI. For simplicity, the “precoding information and number of layers field” is also referred to as a “precoding information field.”

The UE may report UE capability information related to a precoder type and be configured, by a base station, with the precoder type based on the UE capability information by higher layer signaling. The UE capability information may be precoder type information to be used by the UE in PUSCH transmission (which may be indicated, for example, by an RRC parameter “pusch-TransCoherence”).

The UE may determine a precoder to be used for the PUSCH transmission, based on precoder type information (for example, an RRC parameter “codebookSubset”) included in PUSCH configuration information notified by higher layer signaling (for example, a “PUSCH-Config” information element of RRC signaling). The UE may be configured with a PMI subset indicated by the TPMI, by codebookSubset.

Note that the precoder type may be indicated by any of or a combination of at least two of full coherent (fully coherent), partial coherent, and non-coherent (non coherent) (which may be indicated, for example, by a parameter such as “fullyAndPartialAndNonCoherent” or “partialAndNonCoherent.”

For example, the RRC parameter “pusch-TransCoherence” indicating a UE capability may indicate full coherent (fullCoherent), partial coherent (partialCoherent), or non-coherent (nonCoherent). The RRC parameter “codebookSubset” may indicate “fullyAndPartialAndNonCoherent,” “partialAndNonCoherent,” or “nonCoherent.”

Full coherent may mean that all the antenna ports to be used for transmission are synchronized (which may be expressed as being able to be matched in relation to phase, being able to be phase-controlled for each coherent antenna port, being able to have an appropriate precoder for each coherent antenna port, and the like). Partial coherent may mean that some ports of the antenna ports to be used for transmission are synchronized but the ports and the other ports are not synchronized. Non-coherent may mean that the antenna ports to be used for transmission are not synchronized.

Note that a UE that supports the precoder type, full coherent, may be assumed to support the precoder types, partial coherent and non-coherent. A UE that supports the precoder type, partial coherent, may be assumed to support the precoder type, non-coherent.

In the present disclosure, a precoder type, coherency, PUSCH transmission coherence, a coherent type, a coherence type, a codebook type, a codebook subset, a codebook subset type, and the like may be interchangeably interpreted.

The UE may determine a precoding matrix corresponding to the TPMI index obtained from DCI for scheduling UL transmission (for example, DCI format 0_1, this similarly applies below), from a plurality of precoders (which may be referred to as a precoding matrix, a codebook, and the like) for CB based transmission.

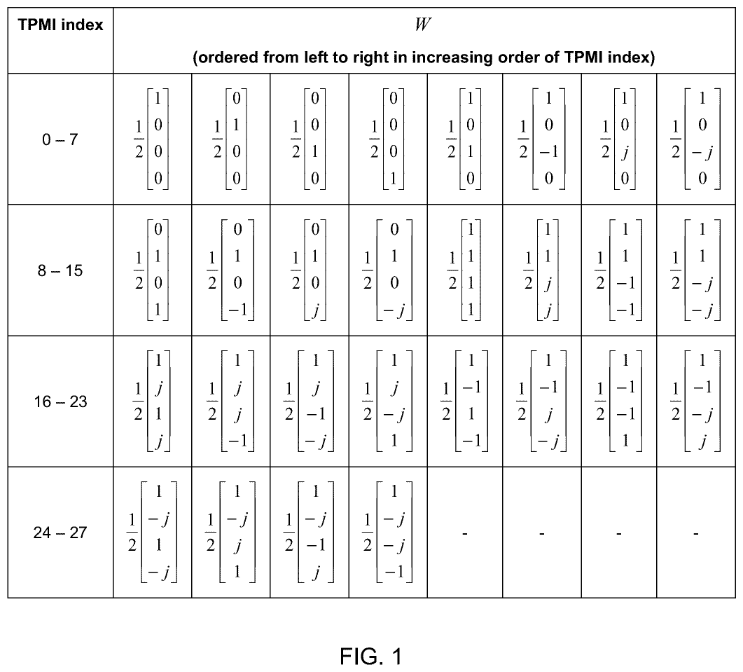

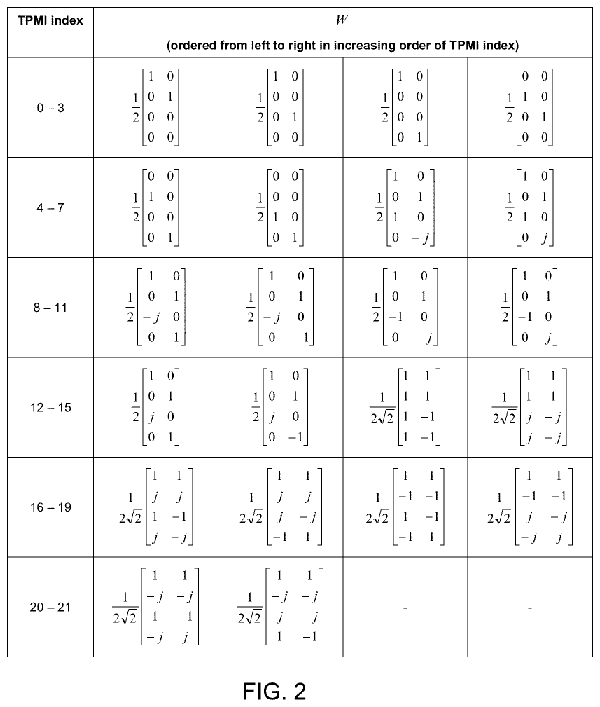

FIGS. 1 to 4 are diagrams to show examples of associations between codebook subsets and TPMI indices. FIG. 1 corresponds to a table of precoding matrices W for single-layer (rank 1) transmission using 4 antenna ports in Rel-16 NR in a case where transform precoding (which may be referred to as a transform precoder) is disabled. FIG. 1 shows corresponding W in ascending order of TPMI indices, from left to right (the same also applies to FIGS. 2 to 4).

Such correspondence (which may be referred to as a table) indicating W corresponding to TPMI indices as that shown in FIGS. 1 to 4 is also referred to as a codebook. Part of this codebook is also referred to as a codebook subset.

In FIG. 1, when the codebook subset (codebookSubset) is fullyAndPartialAndNonCoherent, the UE is notified of a TPMI of any one of 0 to 27, for the single-layer transmission. When the codebook subset is partialAndNonCoherent, the UE is configured with a TPMI of any one of 0 to 11, for the single-layer transmission. When the codebook subset is non-coherent (nonCoherent), the UE is configured with a TPMI of any one of 0 to 3, for the single-layer transmission.

FIGS. 2 to 4 correspond to tables of precoding matrices W for 2 to 4-layer (rank 2 to 4) transmissions in Rel-16 NR, respectively, each using 4 antenna ports in a case where transform precoding is disabled.

According to FIG. 2, a TPMI notified to the UE for 2-layer transmission is from 0 to 21 (codebook subset is fullyAndPartialAndNonCoherent), from 0 to 13 (precoder type is partialAndNonCoherent), or from 0 to 5 (precoder type is nonCoherent).

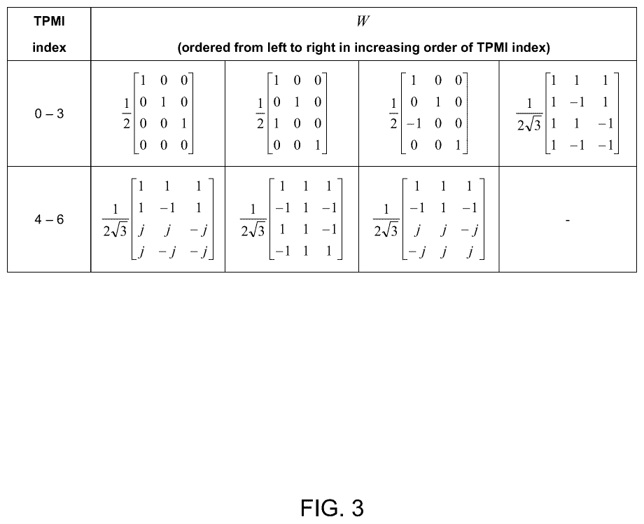

According to FIG. 3, a TPMI notified to the UE for 3-layer transmission is from 0 to 6 (codebook subset is fullyAndPartialAndNonCoherent), from 0 to 2 (precoder type is partialAndNonCoherent), or 0 (precoder type is nonCoherent).

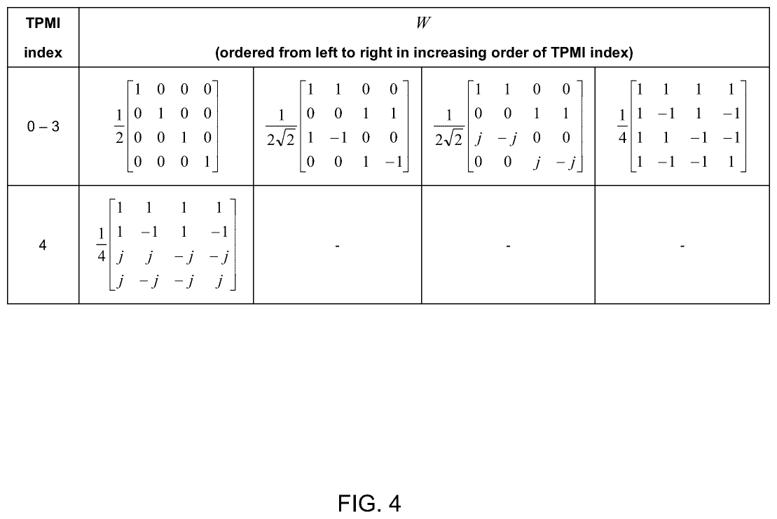

According to FIG. 4, a TPMI notified to the UE for 4-layer transmission is from 0 to 4 (codebook subset is fullyAndPartialAndNonCoherent), from 0 to 2 (precoder type is partialAndNonCoherent), or 0 (precoder type is nonCoherent).

Note that a precoding matrix in which only one element in each column is non-zero may be referred to as a non-coherent codebook. A precoding matrix in which a specific number of elements in each column (which is greater than 1, but is not the number of all the elements in each column) is non-zero may be referred to as a partial coherent codebook. A precoding matrix in which all the elements in each column are non-zero may be referred to as a fully coherent codebook.

The non-coherent codebook and the partial coherent codebook may be referred to as an antenna selection precoder, an antenna port selection precoder, or the like. For example, the non-coherent codebook (non-coherent precoder) may be referred to as a 1-port selection precoder, a 1-port port selection precoder, or the like. The partial coherent codebook (partial coherent precoder) may be referred to as an x-port (x is an integer greater than 1) selection precoder, an x-port port selection precoder, or the like. The fully coherent codebook may be referred to as a non-antenna selection precoder, a full-port precoder, or the like.

Note that, in the present disclosure, the partial coherent codebook may correspond to a codebook obtained by excluding a codebook corresponding to a TPMI indicated for the UE configured with a non-coherent codebook subset (for example, an RRC parameter “codebookSubset”=“nonCoherent”) from a codebook (precoding matrices) corresponding to TPMIs indicated by DCI for codebook based transmission for the UE configured with a fully coherent codebook subset (for example, an RRC parameter “codebookSubset”=“partialAndNonCoherent”) (in other words, in a case of 4-antenna port single-layer transmission, a codebook corresponding to TMPIs=4 to 11).

Note that, in the present disclosure, the fully coherent codebook may correspond to a codebook obtained by excluding a codebook corresponding to a TPMI indicated for the UE configured with a partial coherent codebook subset (for example, an RRC parameter “codebookSubset”=“partialAndNonCoherent”) from a codebook (precoding matrices) corresponding to TPMIs indicated by DCI for codebook based transmission for the UE configured with a fully coherent codebook subset (for example, an RRC parameter “codebookSubset”=“fullyAndPartialAndNonCoherent”) (in other words, in a case of 4-antenna port single-layer transmission, a codebook corresponding to TMPIs=12 to 27).

### (Size of Precoding Information Field)

As mentioned above, the UE may judge, based on a precoding information field of DCI for scheduling a PUSCH (for example, DCI format 0_1/0_2), a TPMI and the number of layers (transmission rank) for the PUSCH.

With respect to a codebook based PUSCH, the number of bits of the precoding information field may be judged (may vary) based on configuration of enabling and disabling of a transform precoder for the PUSCH (for example, a higher layer parameter “transformPrecoder”), configuration of a codebook subset for the PUSCH (for example, a higher layer parameter “codebookSubset”), configuration of a maximum number of layers for the PUSCH (for example, a higher layer parameter “maxRank”), configuration of uplink full-power transmission for the PUSCH (for example, a higher layer parameter “ul-FullPowerTransmission”), the number of antenna ports for the PUSCH, and the like.

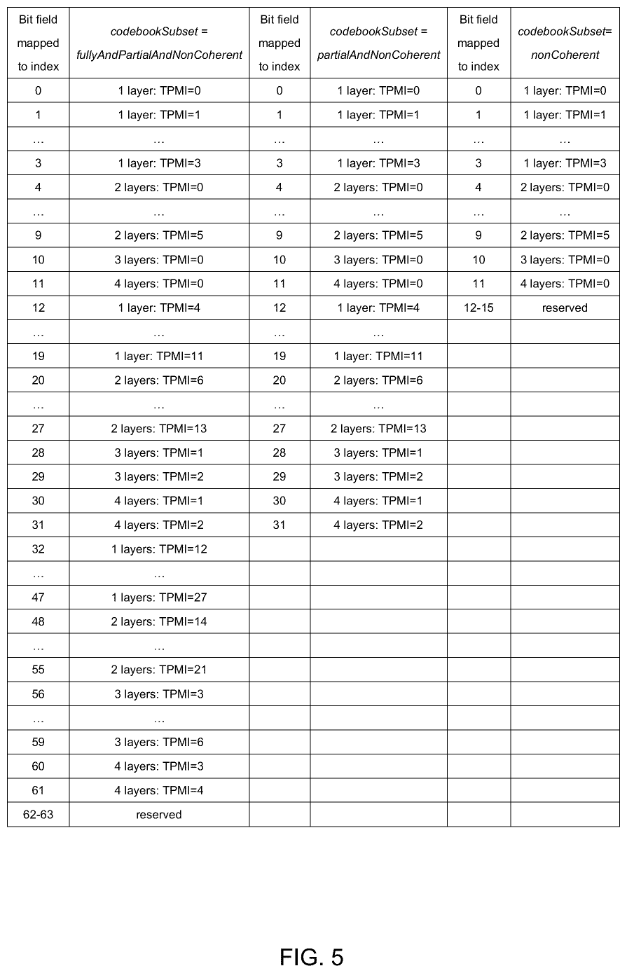

FIG. 5 is a diagram to show an example of correspondence between a value of the precoding information and number of layers field, and the number of layers and a TPMI in Rel-16 NR. The correspondence in the present example is correspondence for 4 antenna ports in a case where the transform precoder is configured to be disabled, the maximum rank (maxRank) is set to 2, 3, or 4, and the uplink full-power transmission is not configured, is set to full-power mode 2 (fullpowerMode2), or is set to full power (fullpower), but is not limited to this. Note that it will be readily apparent to those of ordinary skill in the art that “Bit field mapped to index” illustrated indicates a value of the precoding information and number of layers field.

In FIG. 5, the precoding information field is 6 bits when a fully coherent (fullyAndPartialAndNonCoherent) codebook subset is configured for the UE, is 5 bits when a partial coherent (PartialAndNonCoherent) codebook subset is configured for the UE, and is 4 bits when a non-coherent (nonCoherent) codebook subset is configured for the UE.

Note that, as shown in FIG. 5, the number of layers and a TPMI corresponding to a certain value of the precoding information field may be the same (common) regardless of a codebook subset configured for the UE. For example, in FIG. 5, the numbers of layers and TPMIs indicated by values of the precoding information field=0 to 11 may be the same for fully coherent (fullyAndPartialAndNonCoherent), partial coherent (PartialAndNonCoherent), and non-coherent (nonCoherent) codebook subsets. In FIG. 5, the numbers of layers and TPMIs indicated by values of the precoding information field=0 to 31 may be the same for fully coherent (fullyAndPartialAndNonCoherent) and partial coherent (PartialAndNonCoherent) codebook subsets.

Note that the precoding information field may be 0 bit for a non-codebook based PUSCH. The precoding information field may be 0 bit for a 1-antenna port codebook based PUSCH.

(Transmission with More than Four Antenna Ports)

In Rel-15/16 NR, uplink (UL) Multi Input Multi Output (MIMO) transmission with up to four layers is supported. For future radio communication systems, it is studied that UL transmission with more than four layers is supported for achieving higher spectrum efficiency. For example, for Rel-18 NR, up to 6 rank transmission using 6 antenna ports, up to 6 or 8 rank transmission using 8 antenna ports, and the like are under study.

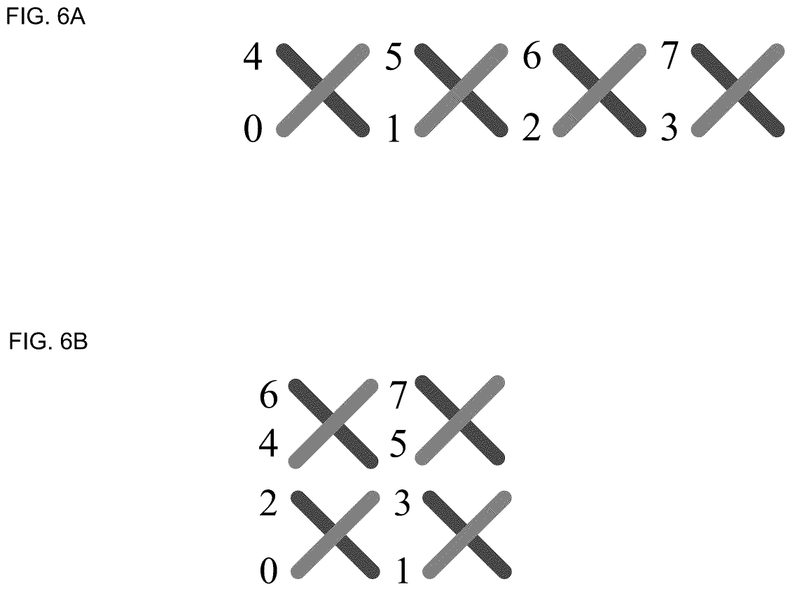

FIGS. 6A and 6B are diagrams to show examples of an antenna layout of 8 antenna ports. FIG. 6A shows an example in which 8 antennas are arranged one-dimensionally (1D), and FIG. 6B shows an example in which 8 antennas are arranged two-dimensionally (2D). FIG. 6A corresponds to an antenna configuration including four cross-polarized wave antennas arranged in the horizontal direction. FIG. 6B corresponds to an antenna configuration including two cross-polarized wave antennas arranged in each of the horizontal and vertical directions.

Note that the numbers illustrated may indicate antenna port numbers corresponding to the antennas.

Note that the antenna layout is not limited to these. For example, the number of panels at which the antennas are arranged, panel directions, coherency of each panel/antenna (full coherent, partial coherent, non-coherent, or the like), an antenna layout in a specific (horizontal, vertical, or the like) direction, and a polarized wave antenna configuration (single-polarized waves, cross-polarized waves, the number of polarized surfaces, or the like) may be different from those of the examples of FIGS. 6A and 6B.

In Rel-15/16 NR, transmission of one codeword (CW) in one PUSCH is supported, but for Rel-18 NR, it is studied that a UE transmits more than one CW in one PUSCH. For example, support of 2-CW transmission for ranks 5 to 8, support of 2-CW transmission for ranks 2 to 8, and the like are under study.

In a UE of Rel. 15 and Rel. 16, it is assumed that only one beam/panel is used for UL transmission at a certain time, but for Rel. 17 (or later versions), it is studied that simultaneous UL transmissions (for example, PUSCH transmissions) with a plurality of beams/plurality of panels to one or more TRPs are performed for improving UL throughput and reliability. Note that the simultaneous PUSCH transmissions with the plurality of beams/plurality of panels may correspond to PUSCH transmissions with more than four layers, or may correspond to PUSCH transmissions with four or less layers.

However, a study of how to determine a precoding matrix for UL transmission using more than four antenna ports (antenna ports more than 4) has not yet been advanced. For example, a study of codebooks for 1 to 8-layer transmissions using 8 antenna ports has not yet been advanced. Unless this is made clear, an increase in communication throughput may be suppressed.

Thus, the inventors of the present invention came up with the idea of a method for appropriately performing UL transmission using more than four antenna ports.

Embodiments according to the present disclosure will be described in detail with reference to the drawings as follows. The radio communication methods according to respective embodiments may each be employed individually, or may be employed in combination.

In the present disclosure, “A/B” and “at least one of A and B” may be interchangeably interpreted. In the present disclosure, “A/B/C” may mean “at least one of A, B, and C.”

In the present disclosure, activate, deactivate, indicate, select, configure, update, determine, and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, an information element (IE), a configuration, and the like may be interchangeably interpreted. In the present disclosure, a Medium Access Control control element (MAC Control Element (CE)), an update command, an activation/deactivation command, and the like may be interchangeably interpreted. Note that the configuration may be performed (or may be notified) based on RRC signaling, and the activation/deactivation may be performed (or may be notified) based on a MAC CE.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, the physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a panel, a UE panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), an antenna, an antenna element, a layer, transmission, a port, an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a downlink Transmission Configuration Indication state (TCI state) (DL TCI state), an uplink TCI state (UL TCI state), a unified TCI state, a common TCI state, quasi-co-location (QCL), QCL assumption, and the like may be interchangeably interpreted.

A spatial relation information Identifier (ID) (TCI state ID) and spatial relation information (TCI state) may be interchangeably interpreted. “Spatial relation information” may be interchangeably interpreted as “a set of spatial relation information”, “one or a plurality of pieces of spatial relation information”, and the like. The TCI state and the TCI may be interchangeably interpreted.

In the present disclosure, a field, a parameter, an information element (IE), and the like may be interchangeably interpreted.

In the following embodiments, a “plurality of” and “two” may be interchangeably interpreted.

The number of layers for PUSCH transmission in the following embodiments may be greater than 4, or may be 4 or less. For example, PUSCH transmission with two CWs in the present disclosure may be performed by 4 or less (for example, two) layers. A maximum number of layers is also not limited to 4 or greater, and may employ 4 or less.

PUSCH transmission in the following embodiments may or may not be assumed to use a plurality of panels (may be applied regardless of a panel).

A number “8” in the following embodiments may be interpreted as an arbitrary number greater than 4 (for example, 6, 10, 12, 16, . . . ), or may be interpreted as an arbitrary number less than or equal to 4 (for example, 1, 2, 3, 4).

### (Radio Communication Method)

### First Embodiment

A first embodiment relates to a precoding matrix W for i-layer transmission (i is an integer, for example, i=1, 2, . . . , 8) using 8 antenna ports.

For correspondence (codebook) between a TPMI index and the above precoding matrix, new correspondence (codebook) not included in existing specifications may be used. This codebook may be referred to as an 8-transmission UL codebook (8 TX UL codebook) or the like.

For the 8-transmission UL codebook, configuration of one or more UE coherent assumptions (UE coherent capabilities) and one or more codebook subsets may be applied.

For 8 ports, an existing RRC parameter (or UE capability) “pusch-TransCoherence,” “codebookSubset,” and the like may be used. For example, for 8 ports, a UE may judge a TPMI index for the 8-transmission UL codebook, based on non-coherent (nonCoherent), partial coherent (partialCoherent), full coherent (fullCoherent), “partialAndNonCoherent,” “fullyAndPartialAndNonCoherent,” and the like.

For 8 ports, a new RRC parameter (or UE capability) may be used. For example, the UE may report, to a network (for example, a base station), capability information indicating support of full/partial/non coherent for a specific number of ports or less, or may be configured with an RRC parameter indicating use of a full/partial/non coherent codebook subset for transmission with a specific number of ports or less.

Note that, in the present disclosure, “less than or equal to,” “less than,” “greater than or equal to,” “greater than,” and the like may be interchangeably interpreted.

For 8 ports, information indicating which port is coherent with which port (or which ports are used as coherent) may be reported from the UE, or may be configured for the UE.

For 8 ports, the UE that supports partial coherent (that has a capability for partial coherent) may transmit information related to which antenna port combination is coherent (included in capability information). This information may be referred to as coherent port information or the like.

The coherent port information may be a bitmap of a size of the number of ports, and mean that ports corresponding to a bit being ‘1’ (or ‘0’) are mutually coherent, for example.

The coherent port information may be information related to a coherent group. Here, the coherent group may include X (X is an integer greater than or equal to 1) coherent ports. The information related to the coherent group may indicate that a certain coherent group includes X ports, or may indicate respective port numbers of X coherent ports included in a certain coherent group.

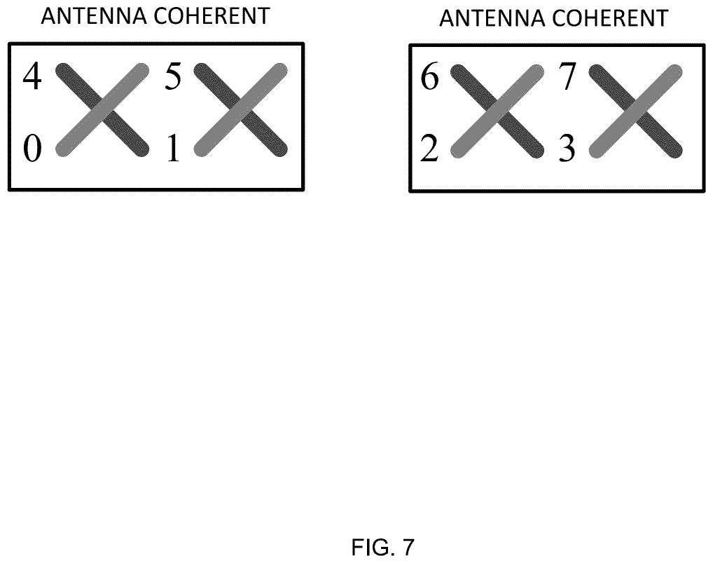

FIG. 7 is a diagram to show an example of an 8-antenna port antenna layout for description of the coherent information of the first embodiment. FIG. 7 is similar to FIG. 6A, but antenna numbers 0, 1, 4, and 5 are mutually coherent, and antenna number 2, 3, 6, and 7 are mutually coherent.

In the present example, the antenna numbers 0, 1, 4, and 5 and the antenna numbers 2, 3, 6, and 7 are referred to as a first coherent group and a second coherent group, respectively. Antennas included in the first coherent group and antennas included in the second coherent group are not mutually coherent.

Regarding FIG. 7, the UE may transmit capability information indicating support of full coherent of four or less ports and support of partial coherent of five or more ports.

Regarding FIG. 7, the UE may transmit, as the coherent port information, at least one of a bitmap “11001100” indicating the first coherent group and a bitmap “11001100” indicating the second coherent group.

Regarding FIG. 7, the UE may report, as the coherent port information, a value of 4 corresponding to the number of ports included in the first coherent group (or inclusion of port numbers 0, 1, 4, and 5 in a certain coherent group) or a value of 4 corresponding to the number of ports included in the second coherent group (or inclusion of port numbers 2, 3, 6, and 7 in another coherent group).

Note that one coherent group may be further divided into a plurality of coherent groups. With such classification of coherent groups, implementation of flexible control can be expected. Regarding FIG. 7, the UE may report 2 (or inclusion of port numbers 2 and 3 in a certain coherent group) as a value indicating the number of ports included in the certain coherent group, or may report 2 (or inclusion of port numbers 6 and 7 in another coherent group) as a value indicating the number of ports included in another coherent group.

The 8-transmission UL codebook for the PUSCH in the first embodiment may be used for a case where at least one of the following is satisfied:
Case where, for UE, transform precoder for PUSCH is configured to be disabled
Case where, for UE, number of ports greater than 4 for PUSCH/SRS (for CB-based PUSCH) is configured by RRC
Case where, for UE, number of ports greater than 4 for PUSCH/SRS (for CB-based PUSCH) is configured/activated/indicated by RRC/MAC CE/DCI

As can be seen from the above description, in the first embodiment, which number of ports a precoding matrix is used for may be semi-statically configured by RRC. In the first embodiment, fall back (or switching) from use of a precoding matrix for more than four ports to use of a precoding matrix for four or less ports may be dynamically performed by a MAC CE/DCI.

Note that the UE may use (refer to) a common 8-transmission UL codebook regardless of an antenna layout (antenna configuration). The UE may use (refer to) a different 8-transmission UL codebook for each antenna layout (antenna configuration).

The UE may report UE capability information related to an antenna layout. For example, based on the UE capability information, the base station may transmit, to the UE, information for indicating/identifying/configuring an 8-transmission UL codebook to be used by the UE. The UE may judge an 8-transmission UL codebook to be used, based on the above reported UE capability information and the above received information for indicating/identifying/configuring the 8-transmission UL codebook.

According to the first embodiment described above, it is possible to appropriately use an 8-transmission UL codebook.

### Second Embodiment

A second embodiment relates to a non-coherent precoder (1-port port selection precoder) for single-layer transmission with 8 antenna ports.

In the present disclosure, for simplicity, a non-coherent precoder, a partial coherent precoder, and a full coherent precoder are also simply described below as an NC (non coherent) precoder, a PC (partial coherent) precoder, and an FC (full coherent) precoder, respectively.

In the present disclosure, for simplicity, an NC/PC/FC precoder for i-layer transmission (i is an integer, i=1 for a single layer) with n antenna ports (n is an integer) is also simply described below as an n-port i-layer NC/PC/FC precoder.

8 matrices W=[1 0 0 0 0 0 0 0]^{T}, [0 1 0 0 0 0 0 0]^{T}, . . . , [0 0 0 0 0 0 0 1]^{T} (T represents a transposed matrix, the same applies to the following description) are conceivable for an 8-port 1-layer NC precoder.

Support of a plurality of 8-port 1-layer NC precoders (capable of being used by the UE, being defined in a specification) is preferable for transmission antenna switching. On the other hand, in terms of communication overhead to be reduced by reducing TPMI index candidates for precoder selection, the UE may not be able to use all of the 8 matrices at a certain timing.

The second embodiment is further broadly classified into four (Embodiments 2.1 to 2.4).

### Embodiment 2.1

In Embodiment 2.1, as the 8-port 1-layer NC precoder, all of the above 8 matrices may be supported, or indication of all of the above 8 matrices may be performable based on TPMI indices.

### Embodiment 2.2

In Embodiment 2.2, as the 8-port 1-layer NC precoder, all of the above 8 matrices may be supported, but some (for example, one or more) of the above 8 matrices may be configured/updated/activated for the UE by RRC/MAC CE. A TPMI index notified by DCI may correspond only to the configured/updated/activated precoder. For example, the RRC/MAC CE may indicate, for the UE, a port index/element index with a value of 1 in a 1-port port selection precoder.

Note that, in the present disclosure, the element index may indicate which element a row (or column) element with a value of 1 (or non-zero value) is. For example, the element index may be equal to port index+1.

### Embodiment 2.3

In Embodiment 2.3, as the 8-port 1-layer NC precoder, at least one precoder of the following from among the above 8 matrices may be supported:
1-port port selection precoder having only odd-numbered port index/element index with value of 1
1-port port selection precoder having only even-numbered port index/element index with value of 1
1-port port selection precoder in which port index/element index with value of 1 is included in i satisfying i mod k=1 (k and l are integers, k is, for example, 4 (=8/2))
1-port port selection precoder obtained by inserting four zeros into 4-port 1-layer NC precoder in existing Rel-15/16 NR

Note that, for determination of which location the above four zeros are inserted into, four zeros may be inserted such that elements of the 4-port 1-layer NC precoder in existing Rel-15/16 NR serve as the first or last four elements of the 8-port 1-layer NC precoder or serve as ports/elements with odd-numbered or even-numbered indices of the 8-port 1-layer NC precoder, for example. In other words, the four zeros may be inserted uniformly (at equal spacings). Note that the 8-port 1-layer NC precoder may be scaled (adjusted) such that a coefficient (or absolute value of each element) becomes 1/√8 (or specific value).

### Embodiment 2.4

In Embodiment 2.4, the 8-port 1-layer NC precoder may be some (for example, one or more) precoders configured/updated/activated by RRC/MAC CE, from among the NC precoders in Embodiment 2.3.

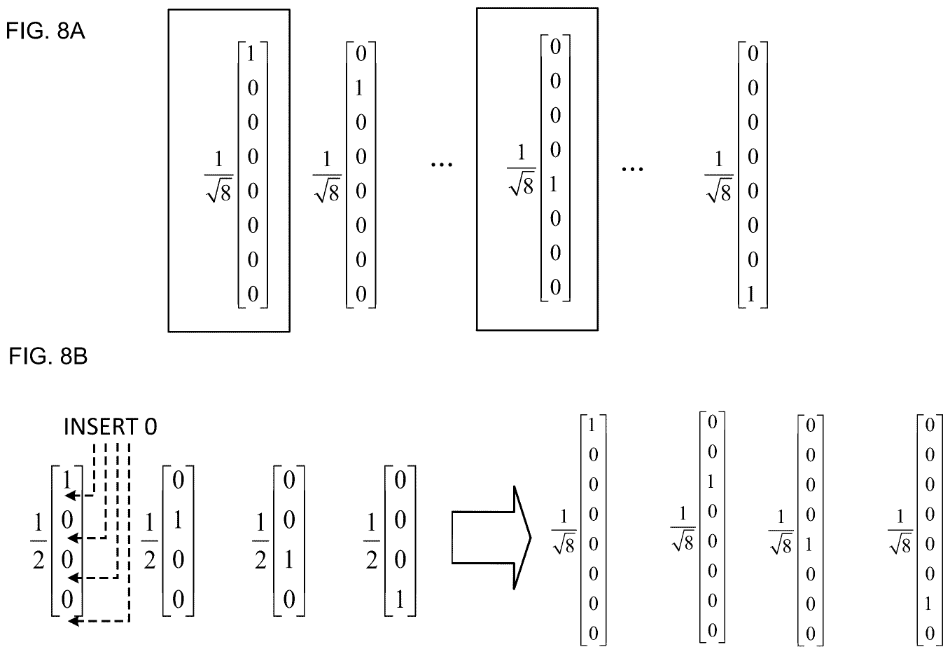

FIGS. 8A and 8B are diagrams to show examples of the 8-port 1-layer NC precoder to be supported, according to the second embodiment. FIG. 8A shows a precoder in which a port index/element index with a value of 1 is included in i satisfying i mod 4=1 (that is, i=1, 5) (corresponds to Embodiment 2.3, two precoders surrounded by rectangles).

FIG. 8B shows an 8-port 1-layer NC precoder (corresponding to Embodiment 2.4) obtained by inserting four zeros into ports/elements with even-numbered indices in each of the 4-port 1-layer NC precoders (TPMI index=0 to 3) shown in FIG. 1 such that its elements serve as ports/elements with odd-numbered indices.

According to the second embodiment described above, the UE can appropriately use an 8-port 1-layer NC precoder.

### Third Embodiment

A third embodiment relates to an 8-port 1-layer PC precoder (port selection precoder for x ports of 8 ports (1<x<8)).

For x-port port selection, a port location with a non-zero value is computed by C(8, x) that is combinations of x of eight. For the x-port port selection, a value of the first port is 1, and a value (in other words, phase) of another port can take {1, j, −1, −j} (here, j is an imaginary number). Considering these, M=C(8, x)*4^{(x-1)} candidates are present for candidates M for the 8-port 1-layer PC precoder. For example, M=C(8, 2)*4⁽²⁻¹⁾=28*4 candidates, M=C(8, 4)*4⁽⁴⁻¹⁾=70*4³ candidates, and M=C(8, 6)*4⁽⁶⁻¹⁾=28*4⁵ candidates are present for x=2, x=4, and x=6, respectively.

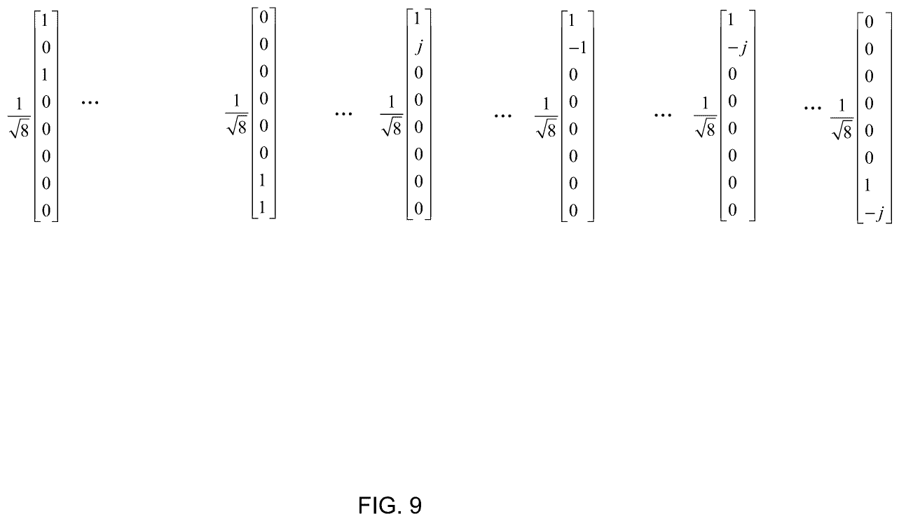

FIG. 9 is a diagram to show an example of the 8-port 1-layer PC precoder to be supported, according to the third embodiment. The present example shows all the candidates (28*4 candidates) for the 8-port 1-layer PC precoder in a case of x=2.

The third embodiment may correspond to an embodiment obtained by interpreting the “NC precoder,” “1-port port selection precoder,” “8,” and “with a value of 1” in the second embodiment (Embodiments 2.1 to 2.4) as a “PC precoder,” “x-port port selection precoder,” “C(8, x)*4^{(x-1)},” and “with a value of 1 for the first port and with a value of {1, j, −1, −j} for another port,” respectively. The third embodiments corresponding to Embodiments 2.1 to 2.4 are referred to as Embodiments 3.1 to 3.4, respectively.

For Embodiment 3.3, any one or combinations of the following may be introduced (employed, used):
Option 1: Only a port selection precoder for x specific ports (for example, x=4) is supported.
Option 2: A port selection precoder for x specific ports is a precoder in which each port index/element index with a non-zero value is included in i satisfying i mod k=1 (k and l are integers, k is, for example, 8/x).
Option 3: For a port selection precoder for x specific ports, only a specific value is supported for a specific port, or ordering of values of the x ports follows a specific rule.
Option 4: When x ports are selected as a group, which x ports can be selected as the group is configured by RRC or determined based on a reported UE capability.

For example, for Option 2 above, 2 ports to be selected may be element indices (1, 5), (2, 6), (3, 7), or (4, 8) if x=2, or 4 ports to be selected may be element indices (1, 3, 5, 7) or (2, 4, 6, 8) if x=4. Option 2 above may mean that locations of port indices are uniformly selected.

For Option 4 above, the group may be a coherent group (mentioned in the first embodiment above). For example, for the UE including the antenna layout of FIG. 7, if x=2, port indices (1, 4) may be grouped together, or port indices (2, 6) may be grouped together. If x=4, port indices (0, 1, 4, 5) may be grouped together, or port indices (2, 3, 6, 7) may be grouped together.

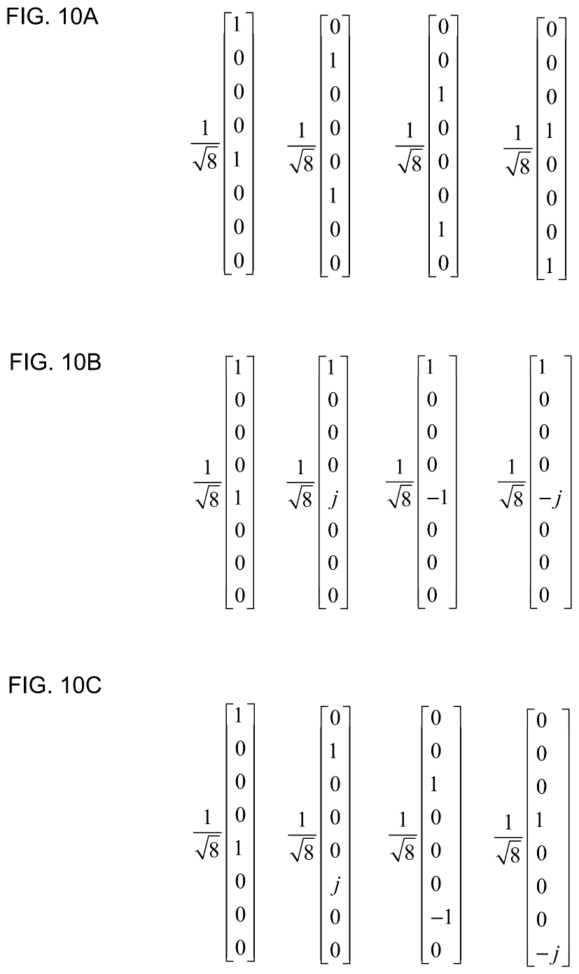

FIGS. 10A to 10C are diagrams to show examples of the 8-port 1-layer PC precoder (x=2) to be supported, according to Embodiment 3.3. FIG. 10A shows an example of a case where Option 2 above and support of only a value ‘1’ for the second port according to Option 3 above are assumed.

FIG. 10B shows an example of a case where support of any value of {1, j, −1, −j} for the second port according to Option 3 above is assumed.

FIG. 10C shows an example of a case where Option 2 above and support of any value of {1, j, −1, −j} for the second port according to Option 3 are assumed.

Note that for Embodiment 3.3, up to eight selection precoders for 2 ports of 8 ports may be obtained by inserting four zeros into each of 4-port 1-layer PC precoders in existing Rel-15/16 NR (for example, the 4-port 1-layer PC precoders (TPMI index=4 to 11) shown in FIG. 1).

For Embodiment 3.3, a 4-port selection precoder may be obtained by inserting four zeros into a 4-port FC precoder in existing Rel-15/16 NR. For example, up to sixteen selection precoders for 4 ports of 8 ports may be obtained by inserting four zeros into each of 4-port 1-layer FC precoders in existing Rel-15/16 NR (the 4-port 1-layer FC precoders (TPMI index=12 to 27) shown in FIG. 1).

RRC configuration/MAC CE update based on these port selection precoders may be available.

Note that the 8-port 1-layer PC precoder may be scaled (adjusted) such that a coefficient (or absolute value of each element) becomes 1/√8 (or specific value).

According to the third embodiment described above, the UE can appropriately use an 8-port 1-layer PC precoder.

### Fourth Embodiment

A fourth embodiment relates to an 8-port 1-layer FC precoder.

As the 8-port 1-layer FC precoder in the fourth embodiment, a precoder W of a DL type I single-panel codebook for number of CSI-RS antenna ports (P_{CSI-RS})=8 in existing Rel-15/16 NR may be used.

First, the DL type I single-panel codebook in existing Rel-15/16 NR will be described.

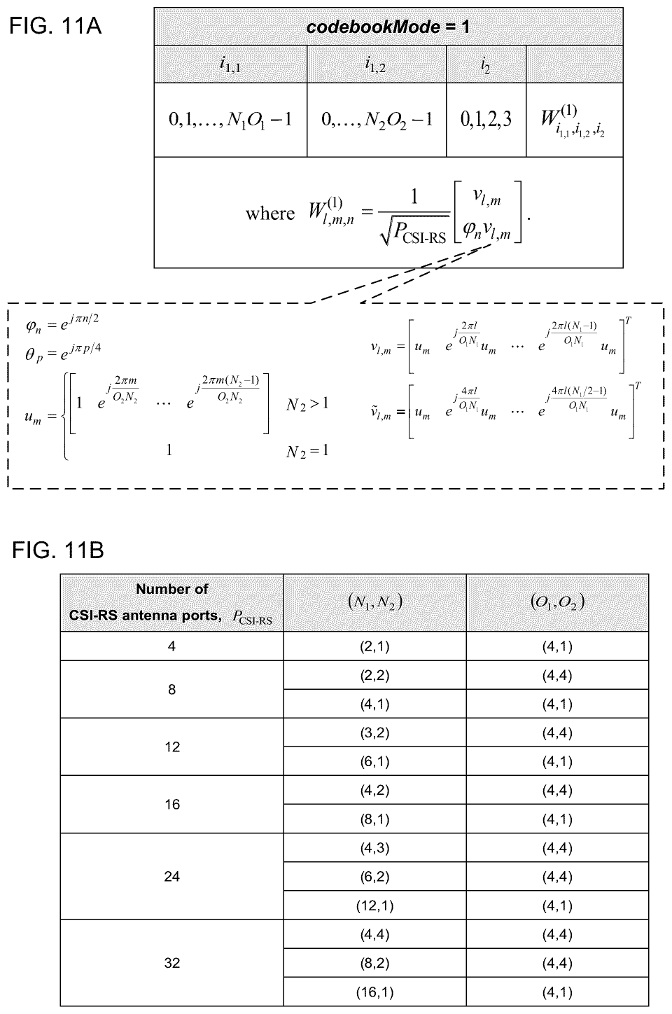

FIGS. 11A and 11B are diagrams to show examples of a codebook for 1-layer CSI reporting using P_{CSI-RS} antenna ports in existing Rel-15/16 NR. The codebook in FIG. 11A corresponds to codebook mode=1. The codebook mode is configured for a UE by an RRC parameter “codebookMode.”

Here, N1 and N2 indicate the number of antenna ports in a first dimension and the number of antenna ports in a second dimension, respectively. For example, N1 and N2 may correspond to the number of antenna ports in the vertical direction and the number of antenna ports in the horizontal direction, respectively, but the directions are not restrictive. For example, the above antenna layout in FIG. 6A may correspond to (N1, N2)=(4, 1), and the above antenna layout in FIG. 6B may correspond to (N1, N2)=(2, 2). N1 and N2 are configured for the UE by an RRC parameter “n1-n2.”

O1 and O2 correspond to an oversampling factor (spatial oversampling rate) corresponding to N1 and an oversampling factor (spatial oversampling rate) corresponding to N2, respectively, and may be obtained based on correspondence in FIG. 11B.

Values of a precoding matrix indicator (PMI) reported to a base station by a UE (reported, for example, by using a CSI report) correspond to i_{1,1}, i_{1,2}, and i₂. i_{1,1}, i_{1,2}, and i₂ correspond to a precoder W. The precoder W corresponds to matrix V_{l,m} with consideration of the first dimension and the second dimension mentioned above.

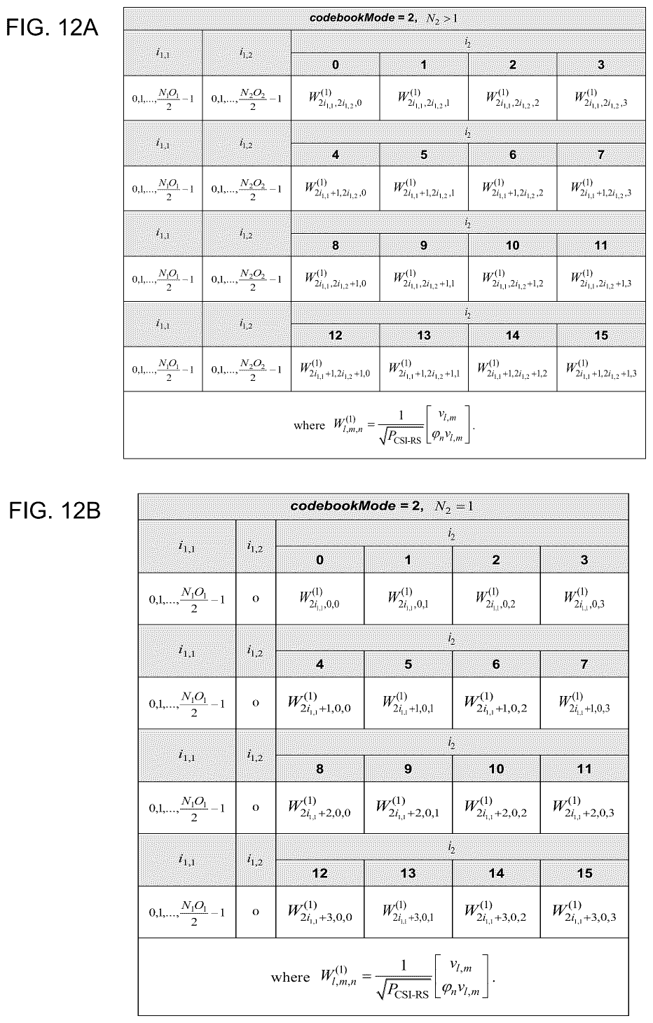

FIGS. 12A and 12B are diagrams to show examples of the codebook for 1-layer CSI reporting using P_{CSI-RS} antenna ports in existing Rel-15/16 NR. The codebook in FIG. 12A corresponds to codebook mode=2 and N2>1. The codebook in FIG. 12B corresponds to codebook mode=2 and N2=1.

Codebook mode=1 corresponds to a case where the same beams (for example, the same spatial domain (SD) beams, beams in the same spatial direction, beams in the same direction) are applied for two different polarized waves and where only phase selection is considered for the two different polarized waves. Codebook mode=2 corresponds to a case where both beams and phase selection are considered for two different polarized waves.

When as the 8-port 1-layer FC precoder in the fourth embodiment, a precoder W of a DL type I single-panel codebook for number of CSI-RS antenna ports (P_{CSI-RS})=8 in existing Rel-15/16 NR (more strictly speaking, W_{l,m,n}⁽¹⁾ in FIGS. 11A, 12A, and 12B) is used, i_{1,1}, i_{1,2}, and i₂ (or variables equivalent to these, the same applies to the following description) may be used for indication of the 8-port 1-layer FC precoder.

Note that the 8-port 1-layer FC precoder in the fourth embodiment may be the same as or different from the precoder W in existing Rel-15/16 NR (may be a precoder obtained by enhancing/changing the W).

A TPMI index notified by DCI may correspond to at least one of the following:
The TPMI index corresponds to (indicates/is) three indices of i_{1,1}, i_{1,2}, and i₂.
The TPMI index corresponds to (indicates/is) a first index related to an index of two of i_{1,1}, i_{1,2}, and i₂ (for example, i_{1,1} and i_{1,2}) and a second index related to an index of the remainder of i_{1,1}, i_{1,2}, and i₂ (for example, i₂).
The TPMI index corresponds to (indicates/is) a third index related to three indices of i_{1,1}, i_{1,2}, and i₂.

Note that correspondence between the index of two of i_{1,1}, i_{1,2}, and i₂ (for example, i_{1,1} and i_{1,2}) and the first index, correspondence between the index of the remainder of i_{1,1}, i_{1,2}, and i₂ (for example, i₂) and the second index, and correspondence between the three indices of i_{1,1}, i_{1,2}, and i₂ and the third index may be predefined by a specification, or may be configured/indicated for the UE by RRC signaling/MAC CE.

For example, the third index may be based on combinations of i_{1,1}, i_{1,2}, and i₂. Third index (TPMI index)=(I2*N2*O2)*a+I2*b+c may represent (i_{1,1}, i_{1,2}, i₂)=(a, b, c). Here, I2 is the number of possible values of i2 for a target codebook (4 in FIG. 11A, 16 in FIGS. 12A and 12B).

For example, for codebook mode=1, TPMI index=0, TPMI index=1, . . . , and TPMI index=(4*N2*O2)*(N1*O1−1)+4*(N2*O2−1)+3 may indicate (i_{1,1}, i_{1,2}, i₂)=(0, 0, 0), (i_{1,1}, i_{1,2}, i₂)=(0, 0, 1), . . . , and (i_{1,1}, i_{1,2}, i₂)=(N1*O1−1, N2*O2−1, 3), respectively.

Note that a possible value of the TPMI index may be configured/indicated by RRC/MAC CE, for controlling overhead of the number of TPMI indices and a precoding information field of DCI. For example, the UE may assume that the TPMI index indicates only a combination of (i_{1,1}, i_{1,2}, i₂) enabled by the RRC/MAC CE, and may determine a precoding information field/size (or possible value) of the TPMI index, based on the above enabled combination (for example, the number of combinations) of (i_{1,1}, i_{1,2}, i₂).

The 8-transmission UL codebook according to the first embodiment may be defined based on the NC precoder according to the second embodiment, the PC precoder according to the third embodiment, and the FC precoder according to the fourth embodiment.

For example, when as a codebook subset, “fullyAndPartialAndNonCoherent” is configured for the UE, the TPMI index may indicate a precoder from NC, PC, and FC precoders. For example, when X1 NC precoders, X2 PC precoders, and X3 FC precoders are supported/configured, a range of the TPMI index (range of the possible value) may be from 0 to (X1+X2+X3−1). Note that X3 may be equal to N1*O1*N2*O2*I2.

In this case, TPMI index=0 to X1−1, TPMI index=X1 to X1+X2−1, and TPMI index=X1+X2 or greater may indicate an NC precoder, a PC precoder, and an FC precoder, respectively. TPMI index=X1+X2 may indicate a first FC precoder (for example, an FC precoder corresponding to (i_{1,1}, i_{1,2}, i₂)=(0, 0, 0)). For example, an FC precoder corresponding to (i_{1,1}, i_{1,2}, i₂)=(a, b, c) may be represented by TPMI index=X1+X2+(I2*N2*O2)*a+I2*b+c.

When as a codebook subset, “partialAndNonCoherent” is configured for the UE, the TPMI index may indicate a precoder from NC and PC precoders. For example, when X1 NC precoders and X2 PC precoders are supported/configured, a range of the TPMI index (range of the possible value) may be from 0 to (X1+X2−1). In this case, TPMI index=0 to X1−1 and TPMI index=X1 or greater may indicate an NC precoder and a PC precoder, respectively.

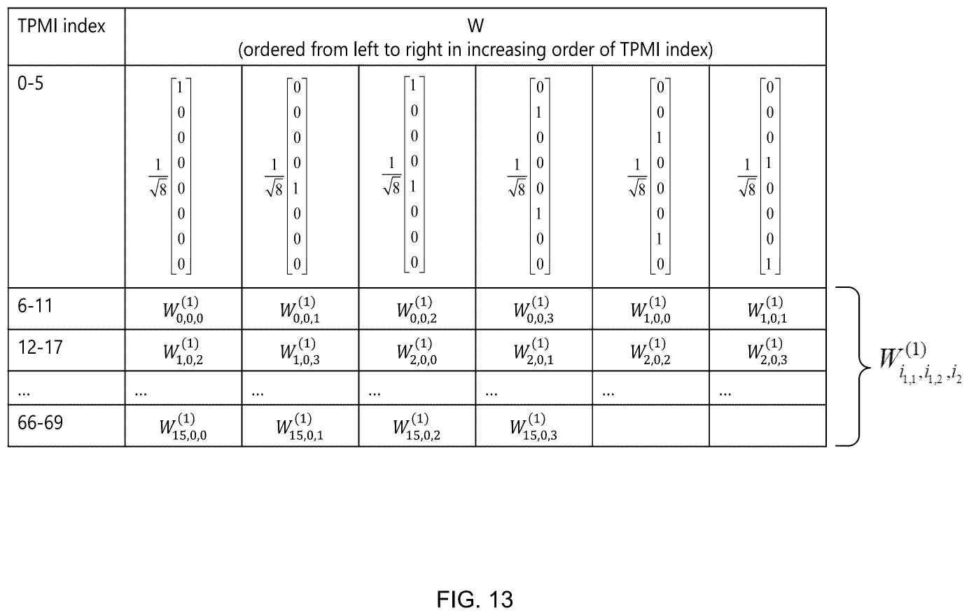

FIG. 13 is a diagram to show an example of associations between the precoders according to the second to fourth embodiments and TPMI indices. The present example assumes, as the above parameters, X1=2, X2=4, X3=64, N1=O1=4, N2=O2=1, and codebook mode=1.

In the present example, X1 NC precoders are two NC precoders shown in FIG. 8A, and X2 PC precoders are four PC precoders shown in FIG. 10A. X3 FC precoders are precoders W_{i_{1,1},i_{1,2},i_{2}}⁽¹⁾ of the type I single-panel codebook in existing Rel-15/16 NR.

In the present example, TPMI index=0 to 1, TPMI index=2 to 5, and TPMI index=6 to 69 correspond to NC precoders, PC precoders, and FC precoders, respectively.

### {Variation of Fourth Embodiment}

### {{Antenna Layout and 8-Transmission UL Codebook}}

For each antenna layout for the UE, a different 8-transmission UL codebook may be supported/configured. For example, for (N1, N2)=(4, 1) and (N1, N2)=(2, 2), different 8-transmission UL codebooks may be supported/configured. For example, the UE may be configured with N1 and N2 by RRC, for 8-transmission UL codebooks, as with existing codebook configuration (for CSI measurement) (RRC information element “codebookConfig”). N1 and N2 may be updated/indicated for 8-transmission UL codebooks by a MAC CE/DCI.

Note that the UE may report capability information related to a UE antenna layout (for example, capability information indicating the number of antennas for each dimension), may report an N1/N2 value to be supported, or report a preferred (prefreed) N1/N2 value. Note that the UE may report the preferred N1/N2 value as capability information or by using a MAC CE/UCI.

The base station may notify the UE of information related to an N1/N2 value for determination of (the number of) FC precoders included in a specific 8-transmission UL codebook, based on the above reported capability information or supported/preferred N1/N2 value, by using RRC/MAC CE/DCI.

One 8-transmission UL codebook may be supported/configured regardless of an antenna layout for the UE. For example, when only an 8-transmission UL codebook following (N1, N2)=(2, 2) is defined in a specification or is configured for the UE, the UE may use the 8-transmission UL codebook in 8-antenna port transmission regardless of an antenna layout for the UE itself (or reported N1/N2 value or configured N1/N2 value).

### {{Configuration of Codebook Mode}}

The UE may support two codebook modes for an 8-transmission UL codebook, and which of the codebook modes a UL codebook is referred to based on may be configured/indicated for the UE by RRC/AC CE/DCI.

The UE may support only one codebook mode for the 8-transmission UL codebook. In this case, the one codebook mode may be codebook mode=1. With this, simplification of a control signal, overhead reduction, and the like can be expected.

Note that N1, N2, the codebook mode, and the like may be configured for the UE by using a UL codebook configuration (which may be referred to as, for example, an RRC information element “ulCodebookConfig”). The UL codebook configuration may be included in at least one of PUSCH configuration information (RRC information element “PUSCH-Config”) and configured grant configuration information (RRC information element “ConfiguredGrantConfig”) and notified to the UE.

### {{O1/O2 Value}}

A value of O1/O2 for the 8-transmission UL codebook may be derived based on the same correspondence between O1/O2 and N1/N2 as that of existing DL (FIG. 11B).

A value of O1/O2 for the 8-transmission UL codebook may be derived to be a value less (or greater) than O1/O2 of existing DL corresponding to same N1/N2. In this case, new correspondence different from the existing correspondence (FIG. 11B) may be defined, and may be used for the 8-transmission UL codebook. In this new correspondence, O1 may be 1, 2, or 4, and O2 may be 1, 2, or 4.

A value of O1/O2 for the 8-transmission UL codebook may be configured/indicated for the UE by RRC/AC CE/DCI. In this case, the UE may report, as UE capability information, a (maximum) O1/O2 value to be supported. The base station may notify the UE of information related to an O1/O2 value for determination of (the number of) FC precoders included in a specific 8-transmission UL codebook, based on the reported (maximum) O1/O2 value to be supported, by using RRC/MAC CE/DCI.

### {{i2 Value}}

A range of possible values of i2 for the 8-transmission UL codebook may be narrower (maximum value of candidate values thereof may be smaller) than that of possible values of i2 for DL in existing Rel. 15/16. In this case, reduction of overhead for the number of precoders and TPMI notification by DCI can be expected.

For example, for codebook mode=1 for the 8-transmission UL codebook, only 0 or 1 may be supported/predefined/configured as the possible values of i2. In this case, φₙ used for computation of the precoder W may not be existing φₙ=e^{jnn/2}, and may be φₙ=e^{jnn}. In other words, φₙ used for computation of the precoder W may be φₙ=e^{jn2n/I2} (I2 is the number of possible values of i2, as mentioned above).

Note that a range of possible values of i2 for the 8-transmission UL codebook may be broader (maximum value of candidate values thereof may be greater) than that of possible values of i2 for DL in existing Rel. 15/16.

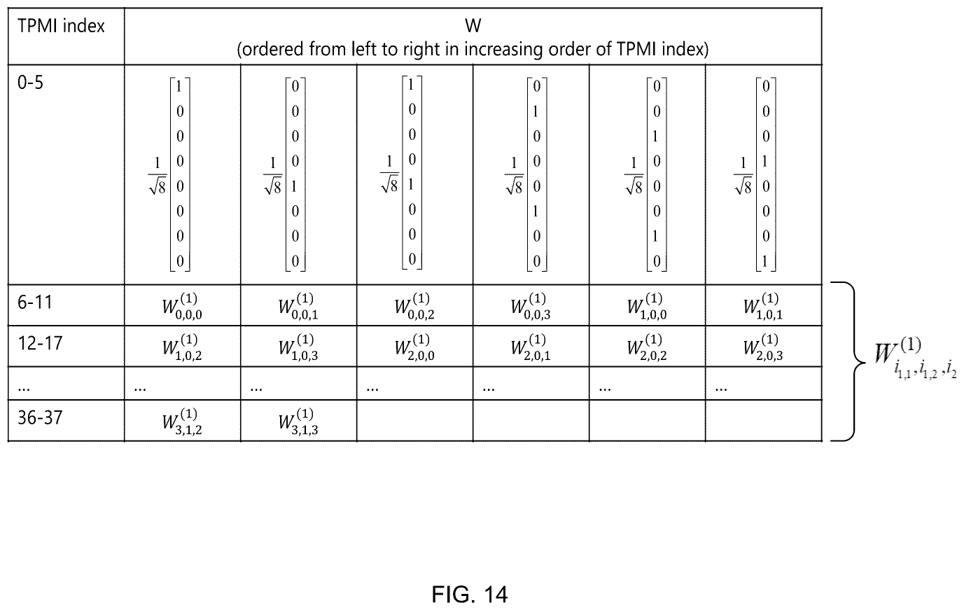

FIG. 14 is a diagram to show an example of the 8-transmission UL codebook according to variation of the fourth embodiment. The present example assumes, as the above parameters, X1=2 and X2=4. Only codebook mode=1 is supported for the 8-transmission UL codebook. Furthermore, for the 8-transmission UL codebook, (N1, N2)=(2, 2) is predefined or configured for the UE, (O1, O2)=(2, 1) is predefined or configured for the UE, and I2=4 is predefined or configured for the UE.

In this case, X3=N1*O1*N2*O2*I2=32. In FIG. 14, possible values of the TPMI index are reduced from 69 to 37, as compared with those of FIG. 13.

Note that X3=8 in a case where for the 8-transmission UL codebook, (N1, N2)=(2, 2) is predefined or configured for the UE, (O1, O2)=(1, 1) is predefined or configured for the UE, and I2=2 is predefined or configured for the UE.

Note that the 8-port 1-layer FC precoder may be scaled (adjusted) such that a coefficient (or absolute value of each element) becomes 1/√8 (or specific value).

According to the fourth embodiment described above, the UE can appropriately use an 8-port 1-layer FC precoder.

### Fifth Embodiment

A fifth embodiment relates to an 8-port 2-layer NC precoder.

The 8-port 2-layer NC precoder may be configured to include two different 1-port selection precoders in column vectors. Hereinafter, a precoder and a vector may be interchangeably interpreted.

For example, at least one of matrices constituted by two 1-port selection vectors (64 vectors) obtained by combining two 1-port selection vectors (8 vectors, same column vector as the 8-port 1-layer NC precoder in the second embodiment) with each other may be used as the 8-port 2-layer NC precoder.

The fifth embodiment is further broadly classified into four (Embodiments 5.1 to 5.4).

### Embodiment 5.1

In Embodiment 5.1, as the 8-port 2-layer NC precoder, all the combinations of the above 2 vectors (64 vectors) may be supported, or indication of all of the above 64 vectors may be performable based on TPMI indices (DCI).

### Embodiment 5.2

In Embodiment 5.2, as the 8-port 2-layer NC precoder, all of the above 64 vectors may be supported, but some (for example, one or more) of the above 64 vectors may be configured/updated/activated for a UE by RRC/MAC CE. A TPMI index notified by DCI may correspond only to the configured/updated/activated precoder. For example, the RRC/MAC CE may specify, for the UE, two port indices/element indices with values of 1 in a 1-port port selection precoder.

### Embodiment 5.3

In Embodiment 5.3, as the 8-port 2-layer NC precoder, at least one of precoders including the following two vectors (first vector and second vector), from among the above 64 vectors, may be supported:
A first vector is selected in accordance with the rule described in the second embodiment, and a second vector is determined/selected, based on the first vector, in accordance with a specific rule.
The two vectors are determined/selected from 8-port 1-layer NC precoders configured (or used by the UE).
The two vectors are respective column vectors obtained by inserting four zeros into each column of a 4-port 2-layer NC precoder in existing Rel-15/16 NR.

Note that the above specific rule may be, for example, a rule in which when a port index/element index with a value of 1 in the selected first vector (8-port 1-layer NC precoder) is i (i is an integer), it is determined that the second vector is an 8-port 1-layer NC precoder having a port index/element index i+N (N is an integer) with a value of 1.

Note that, for determination of which location the above four zeros are inserted into, four zeros may be inserted such that elements of the 4-port 2-layer NC precoder in existing Rel-15/16 NR serve as the first or last four elements of the 8-port 2-layer NC precoder or serve as ports/elements with odd-numbered or even-numbered indices of the 8-port 2-layer NC precoder, for example. Note that the 8-port 2-layer NC precoder may be scaled (adjusted) such that a coefficient (or absolute value of each element) becomes 1/√8 (or specific value).

### Embodiment 5.4

In Embodiment 5.4, the 8-port 2-layer NC precoder may be some (for example, one or more) precoders configured/updated/activated by RRC/MAC CE, from among the NC precoders in Embodiment 5.3.

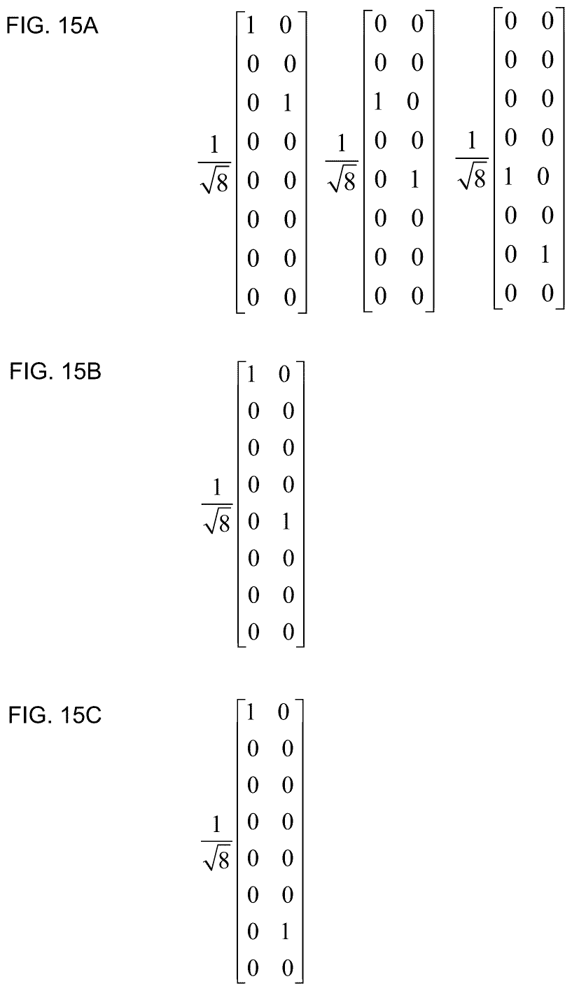

FIGS. 15A to 15C are diagrams to show examples of the 8-port 2-layer NC precoder to be supported, according to the fifth embodiment. FIG. 15A shows an example of the precoder for which two vectors are determined in accordance with the above rule for N=2 in Embodiment 5.3. The present example shows respective cases of i=1, 3, and 5. FIG. 15B shows an example of the precoder for which two vectors are determined in accordance with the above rule for N=4 (i=1) in Embodiment 5.3. FIG. 15C shows an example of the precoder for which two vectors are determined in accordance with the above rule for N=6 (i=1) in Embodiment 5.3.

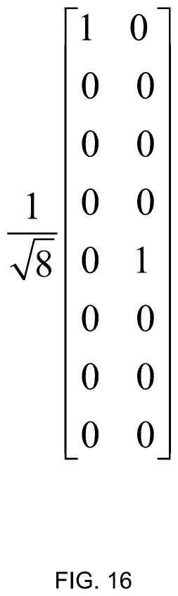

FIG. 16 is a diagram to show an example of the 8-port 2-layer NC precoder to be supported, according to the fifth embodiment. FIG. 16 is an example of a case where two precoders shown in FIG. 8A are configured as (candidates for) an 8-port 1-layer NC precoder. In this case, the UE may use, as the 8-port 2-layer NC precoder, only the illustrated precoder including these two precoders as column vectors.

According to the fifth embodiment described above, the UE can appropriately use an 8-port 2-layer NC precoder.

### Sixth Embodiment

A sixth embodiment relates to an 8-port 2-layer PC precoder.

The 8-port 2-layer PC precoder may be configured to include two different x-port selection precoders in column vectors.

For example, at least one of matrices constituted by two x-port selection vectors obtained by combining two x-port (1<x<8) selection vectors (same column vector as the 8-port 1-layer PC precoder in the third embodiment) with each other may be used as the 8-port 2-layer PC precoder.

The sixth embodiment may correspond to an embodiment obtained by interpreting the “NC precoder,” “1-port port selection precoder,” “8,” and “with a value of 1” in the fifth embodiment (Embodiments 5.1 to 5.4) as a “PC precoder,” “x-port port selection precoder,” “C(8, x)*4^{(x-1)},” and “with a value of 1 for the first port and with a value of {1, j, −1, −j} for another port,” respectively. The sixth embodiments corresponding to Embodiments 5.1 to 5.4 are referred to as Embodiments 6.1 to 6.4, respectively.

For Embodiment 6.3, any one or combinations of the following may be introduced (employed, used):
Option 1: Two vectors are port selection precoders for x same ports (for example, x=4).
Option 2: Two vectors are port selection precoders for x same ports, and each of these precoders is a precoder in which each port index/element index with a non-zero value is included in i satisfying i mod k=1 (k and l are integers, k is the same for the two vectors (for example, 8/x), and l varies for the two vectors).
Option 3: For a port selection precoder for x specific ports, only a specific value is supported for a specific port, or ordering of values of the x ports follows a specific rule.
Option 4: When x ports are selected as a group, which x ports can be selected as the group is configured by RRC or determined based on a reported UE capability.
Option 5: A port index/element index with a non-zero value of a first vector and a port index/element index with a non-zero value of a second vector belong to different groups.

For Options 4 and 5 above, the group may be a coherent group (mentioned in the first embodiment above).

Note that for Embodiment 6.3, a selection precoder for 2 ports of 8 ports may be obtained by inserting four zeros into each of 4-port 2-layer PC precoders in existing Rel-15/16 NR (for example, the 4-port 2-layer PC precoders (TPMI index=6 to 13) shown in FIG. 2).

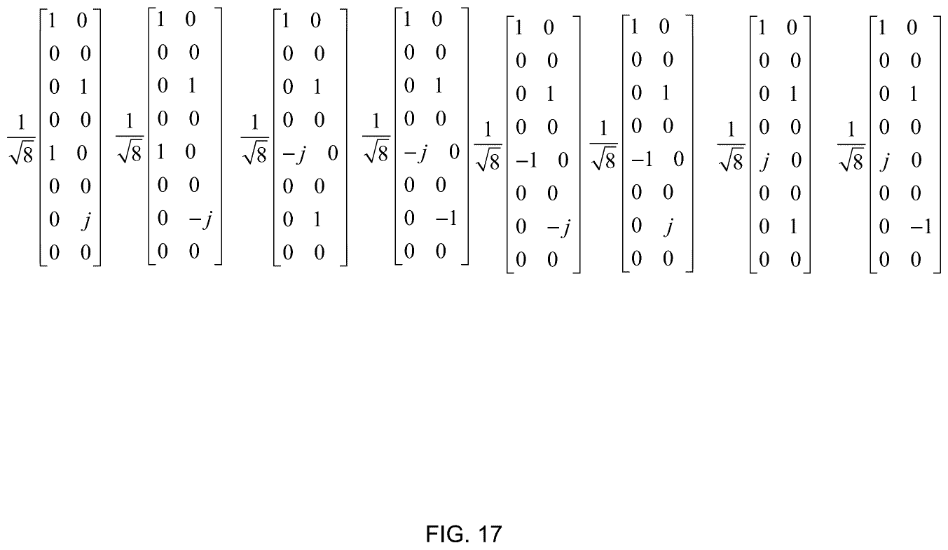

FIG. 17 is a diagram to show an example of the 8-port 2-layer PC precoder according to the sixth embodiment. FIG. 17 shows an 8-port 2-layer NC precoder obtained by inserting four zeros into ports/elements with even-numbered indices in each of the 4-port 2-layer PC precoders (TPMI index=6 to 13) shown in FIG. 2 such that its elements serve as ports/elements with odd-numbered indices.

For Embodiment 6.3, a 4-port selection precoder may be obtained by inserting four zeros into a 4-port FC precoder in existing Rel-15/16 NR. For example, a selection precoder for 4 ports of 8 ports may be obtained by inserting four zeros into each of 4-port 2-layer FC precoders in existing Rel-15/16 NR (the 4-port 2-layer FC precoders (TPMI index=14 to 21) shown in FIG. 2).

RRC configuration/MAC CE update based on these port selection precoders may be available.

Note that the 8-port 2-layer PC precoder may be scaled (adjusted) such that a coefficient (or absolute value of each element) becomes 1/√8 (or specific value).

According to the sixth embodiment described above, the UE can appropriately use an 8-port 2-layer PC precoder.

### Seventh Embodiment

A seventh embodiment relates to an 8-port 2-layer FC precoder.

The seventh embodiment corresponds to an embodiment obtained by similarly applying, to a 2-layer precoder, use of the precoder W of the DL type I single-panel codebook in the fourth embodiment as an 8-port 1-layer FC precoder. Those of ordinary skill in the art will be able to obtain the 8-port 2-layer FC precoder, based on the precoder W of the DL type I single-panel codebook, according to the description of the embodiments above, and thus overlapped description thereof will not be repeated here.

Supplements to the seventh embodiment will be described below in relation to a difference between a codebook for 1-layer CSI reporting and a codebook for 2-layer CSI reporting.

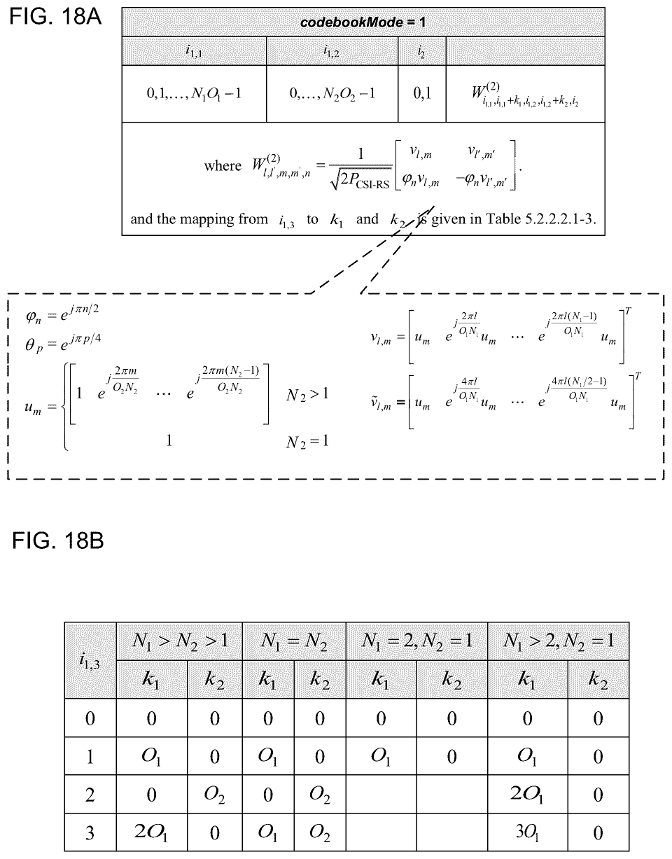

FIGS. 18A and 18B are diagrams to show examples of the codebook for 2-layer CSI reporting using P_{CSI-RS} antenna ports in existing Rel-15/16 NR. The codebook in FIG. 18A corresponds to codebook mode=1. A PMI value for the 2-layer CSI reporting is based not only on i_{1,1}, i_{1,2}, and i₂, but also on i_{1,3}. i_{1,1}, i_{1,2}, i₂, and i_{1,3} correspond to a precoder W. i_{1,3} may be associated with O1, O2, N1, N2, and the like, and may be obtained based on correspondence in FIG. 18B.

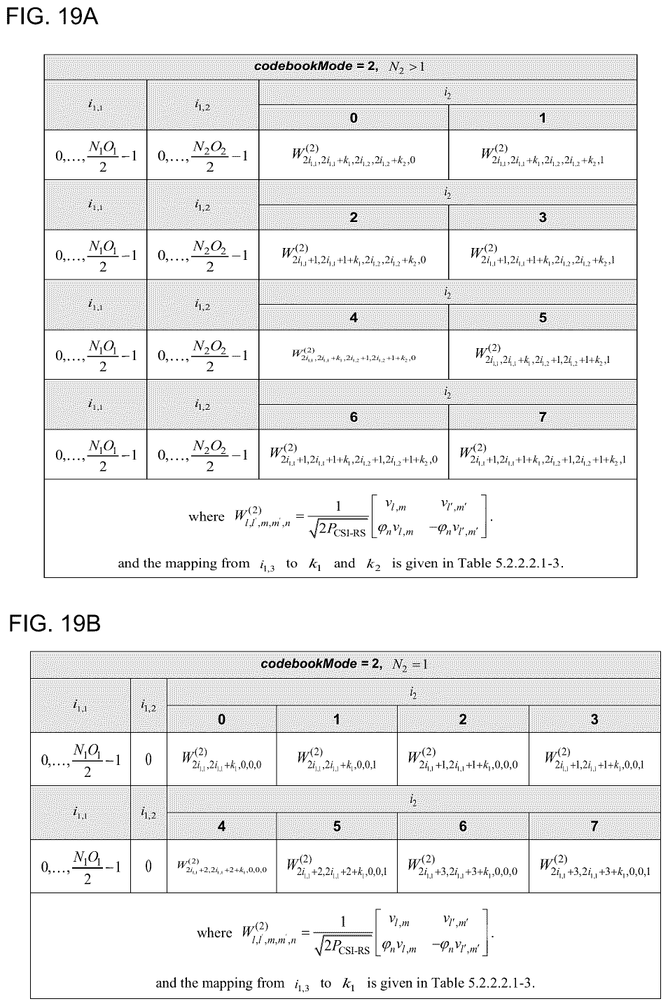

FIGS. 19A and 19B are diagrams to show examples of the codebook for 2-layer CSI reporting using P_{CSI-RS} antenna ports in existing Rel-15/16 NR. The codebook in FIG. 19A corresponds to codebook mode=2 and N2>1. The codebook in FIG. 19B corresponds to codebook mode=2 and N2=1.

When as the 8-port 1-layer FC precoder in the seventh embodiment, a precoder W of a DL type I single-panel codebook for number of CSI-RS antenna ports (P_{CSI-RS})=8 in existing Rel-15/16 NR (more strictly speaking, W_{l,l′,m,m′,n}⁽²⁾ in FIGS. 18A, 19A, and 19B) is used, i_{1,1}, i_{1,2}, i₂, and i_{1,3} (or variables equivalent to these) may be used for indication of the 8-port 1-layer FC precoder.

A range of possible values of i_{1,3} for an 8-transmission UL codebook may be narrower (maximum value of candidate values thereof may be smaller) than that of possible values of i_{1,3} for DL in existing Rel. 15/16. In this case, reduction of overhead for the number of precoders and TPMI notification by DCI can be expected.

Note that the range of possible values of i_{1,3} for the 8-transmission UL codebook may be broader (maximum value of candidate values thereof may be greater) than that of possible values of i_{1,3} for DL in existing Rel. 15/16.

Note that the 8-port 2-layer FC precoder may be scaled (adjusted) such that a coefficient (or absolute value of each element) becomes 1/√8 (or specific value).

According to the seventh embodiment described above, the UE can appropriately use an 8-port 2-layer FC precoder.

### Eighth Embodiment

An eighth embodiment relates to an 8-port m-layer NC/PC/FC precoder (m is an integer of m>2).

The eighth embodiment corresponds to an embodiment obtained by applying/interpreting, to/as an 8-port m-layer NC/PC/FC precoder, the 8-port 1 or 2-layer NC/PC/FC precoder determination/selection method described in the embodiment above. Those of ordinary skill in the art will be able to understand the description of the eighth embodiment, according to the description of the embodiments above, and thus overlapped description thereof will not be repeated here.

Supplements to the eighth embodiment will be described below.

The 8-port m-layer NC precoder may correspond to a matrix obtained by combining m 1-port selection vectors with each other in accordance with a specific rule. The 8-port m-layer NC precoder may correspond to a matrix including respective column vectors obtained by uniformly inserting four zeros into each column of an existing 4-port NC precoder (for example, 4-port m-layer NC precoder).

The 8-port m-layer PC precoder may correspond to a matrix obtained by combining m x-port selection vectors (for example, x=2, 4, 6) with each other in accordance with a specific rule. The 8-port m-layer PC precoder may correspond to a matrix including respective column vectors obtained by uniformly inserting four zeros into each column of an existing 4-port PC/FC precoder (for example, 4-port m-layer PC/FC precoder).

The 8-port m-layer FC precoder may correspond to a precoder included in an 8-port codebook for existing DL (for example, codebook for CSI reporting). The 8-port m-layer FC precoder may be determined in accordance with constraints/configuration related to a codebook mode, N1, N2, O1, O2, i_{1,1}, i_{1,2}, candidate values for i₂, candidate values for 11,3, and the like.

According to the eighth embodiment described above, the UE can appropriately use an 8-port m-layer NC/PC/FC precoder (m is an integer of m>2).

### <Supplement>

Note that at least one of the above-described embodiments may be applied only to a UE that has reported specific UE capability or that supports the specific UE capability.

The specific UE capability may indicate at least one of the following:
Support of processing/operation/control/information for at least one of above embodiments
Support of PUSCH transmission using more than four antenna ports
Support of 8-port m-layer NC/PC/FC precoder (m=1, 2, . . . )

The specific UE capability may be capability applied over all the frequencies (commonly irrespective of frequency), capability per frequency (for example, a cell, a band, a BWP), capability per frequency range (for example, FR1, FR2, FR3, FR4, FR5), or capability per subcarrier spacing.

The specific UE capability may be capability applied over all the duplex schemes (commonly irrespective of duplex scheme) or capability per duplex scheme (for example, time division duplex (TDD) or per frequency division duplex (FDD)).

At least one of the above-described embodiments may be applied when the UE is configured with specific information related to the above-described embodiment by higher layer signaling. For example, the specific information may be configuration information for a PUSCH using more than four antenna ports, any RRC parameter for specific release (for example, Rel. 18), or the like.

When not supporting at least one of the above specific UE capabilities or not configured with the above specific information, the UE may apply operation of Rel. 15/16, for example.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

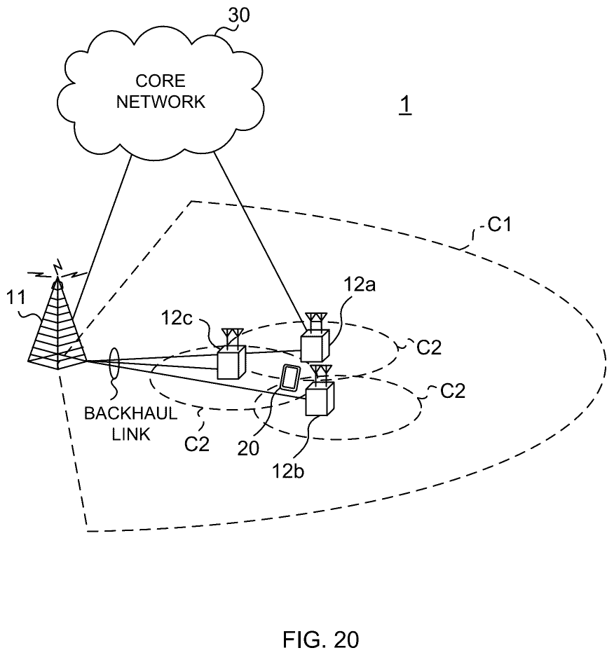

FIG. 20 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHZ or less (sub-6 GHZ), and FR2 may be a frequency band which is higher than 24 GHZ (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-S-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data,” and the PUSCH may be interpreted as “UL data.”

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

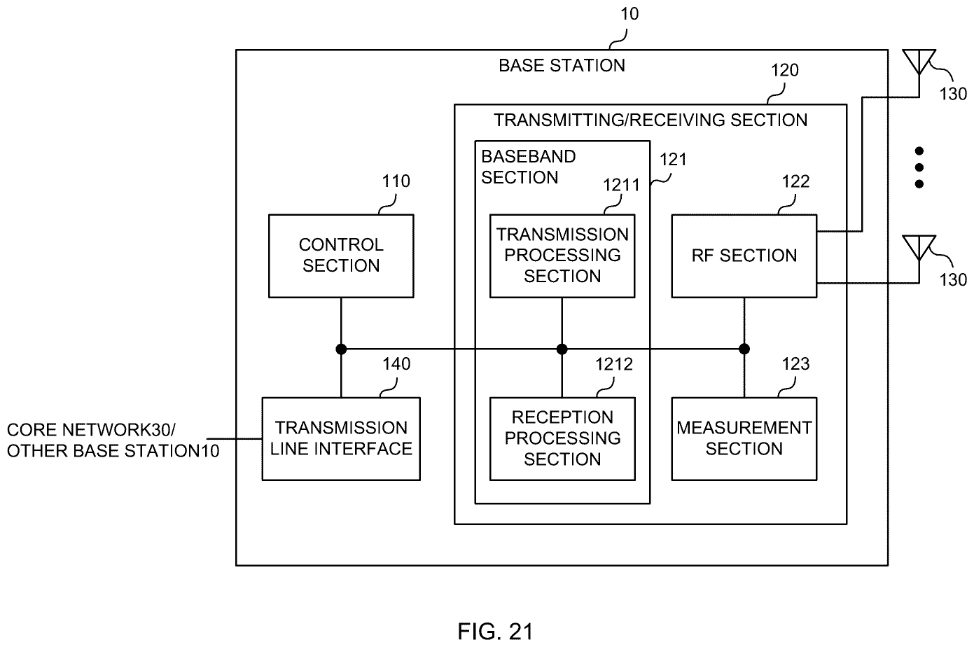

FIG. 21 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

Note that the transmitting/receiving section 120 may transmit, to the user terminal 20, information related to a codebook for transmission with a certain number of layers using more than four antenna ports.

The transmitting/receiving section 120 may receive, based on a precoder determined based on the codebook, an uplink transmission (for example, a PUSCH) transmitted from the user terminal 20.

### (User Terminal)

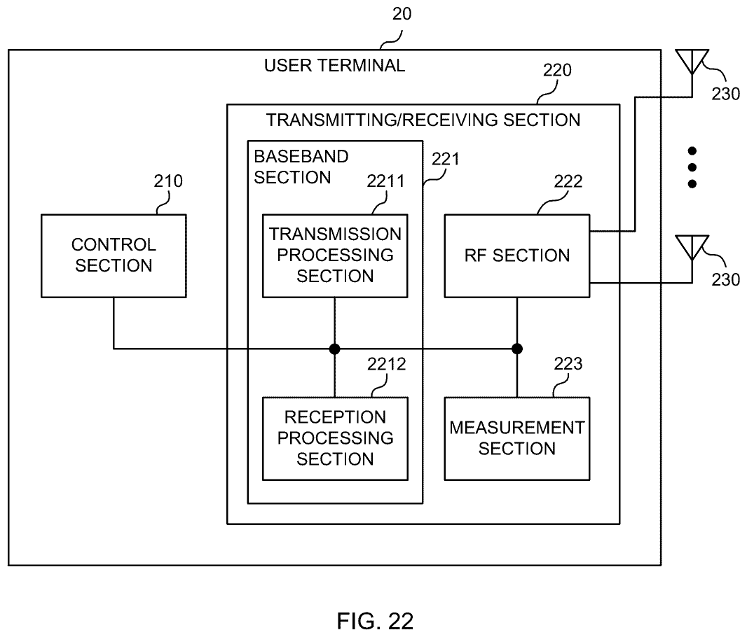

FIG. 22 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-S-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure received power (for example, RSRP), received quality (for example, RSRQ, SINR, SNR), signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

Note that the control section 210 may determine a precoder, based on a codebook for transmission with a certain number of layers using more than four antenna ports.

The transmitting/receiving section 220 may perform uplink transmission, based on the precoder.

The codebook may include at least one of a non-coherent precoder, a partial coherent precoder, and a full-coherent precoder.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

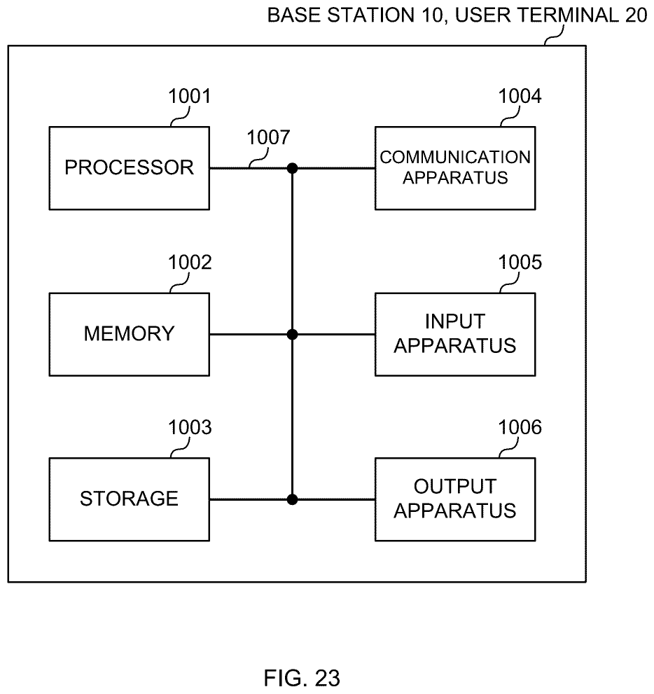

For example, a base station, a user terminal, and so on according to one embodiment of the present disclosure may function as a computer that executes the processes of the radio communication method of the present disclosure. FIG. 23 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIS.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE may not assume transmission/reception of a certain signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on.

The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

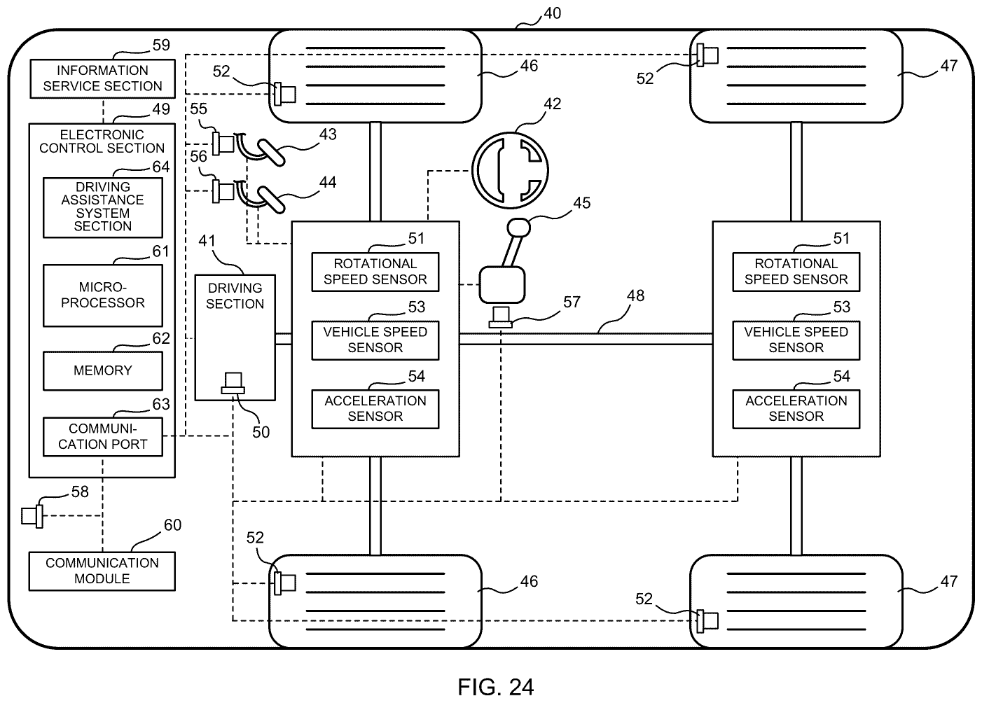

FIG. 24 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 at least includes a steering wheel, and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 included in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes various devices for providing (outputting) various pieces of information such as drive information, traffic information, and entertainment information, such as a car navigation system, an audio system, a speaker, a display, a television, and a radio, and one or more ECUs that control these devices. The information service section 59 provides various pieces of information/services (for example, multimedia information/multimedia service) for an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor, and one or more ECUs that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, via the communication port 63, the communication module 60 transmits and receives data (information) to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 can be controlled by the microprocessor 61 of the electronic control section 49, and is a communication device that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals from the various sensors 50 to 58 described above input to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the various pieces of information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may perform control of the driving section 41, the steering section 42, the accelerator pedal 43, the brake pedal 44, the shift lever 45, the right and left front wheels 46, the right and left rear wheels 47, the axle 48, the various sensors 50 to 58, and the like included in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods, next-generation systems that are enhanced, modified, created, or defined based on these, and the like. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1.-6. (canceled)

7. A terminal comprising:
a processor that determines a precoder, based on a codebook for transmission with a certain number of layers, the transmission using more than four antenna ports; and
a transmitter that performs uplink (UL) transmission, based on the precoder.

8. The terminal according to claim 7, wherein when the codebook is a non-coherent codebook, the non-coherent codebook includes eight types of 8-port 1-layer non-coherent precoders.

9. The terminal according to claim 7, wherein when the codebook is a non-coherent codebook, the non-coherent codebook includes, for m layers, at least one type of 8-port m-layer non-coherent precoder in which m 1-port selection vectors are combined.

10. The terminal according to claim 7, wherein when a first antenna layout is configured by higher layer signaling, the codebook is a full-coherent codebook for the first antenna layout, and when a second antenna layout is configured by the higher layer signaling, the codebook is a full-coherent codebook for the second antenna layout.

11. The terminal according to claim 7, wherein the transmitter transmits capability information indicating support of at least one of a full-coherent codebook for a first antenna layout and a full-coherent codebook for a second antenna layout.

12. A radio communication method for a terminal, comprising:
determining a precoder, based on a codebook for transmission with a certain number of layers, the transmission using more than four antenna ports; and
performing uplink (UL) transmission, based on the precoder.

13. A base station comprising:
a transmitter that transmits, to a terminal, information related to a codebook for transmission with a certain number of layers, the transmission using more than four antenna ports; and
a receiver that receives uplink (UL) transmission transmitted based on a precoder that is determined based on the codebook.

14. A system comprising a terminal and a base station, wherein
the terminal comprises:
a processor that determines a precoder, based on a codebook for transmission with a certain number of layers, the transmission using more than four antenna ports; and
a transmitter that performs uplink (UL) transmission, based on the precoder, and
the base station comprises:
a receiver that receives the UL transmission.
